(19) United States
(12) Patent Application Publication
(10) Pub. No.: US 2020/0156998 A1
(43) Pub. Date: May 21, 2020

(54) CEMENT FORMULATIONS AND METHODS

(71) Applicant: Geofortis Pozzolans LLC, Moraga, CA (US)

(72) Inventors: James M. DONOVAN, Reno, NV (US); Jason GREISER, Reno, NV (US); David MCMURTRY, Reno, NV (US)

(21) Appl. No.: 16/774,733

(22) Filed: Jan. 28, 2020

Related U.S. Application Data
(63) Continuation of application No. 15/699,961, filed on Sep. 8, 2017, now abandoned.
(60) Provisional application No. 62/384,917, filed on Sep. 8, 2016.
(60) Provisional application No. 62/531,179, filed on Jul. 11, 2017.

(51) Int. Cl. C04B 14/28; C04B 14/14; C04B 28/04; C04B 28/08; C04B 28/02; C04B 40/00

(52) U.S. Cl. CPC C04B 14/28; C04B 14/14; C04B 28/04; Y02W 30/92; C04B 28/021; C04B 40/0042; Y02W 30/94; C04B 28/08

(57) ABSTRACT

Disclosed are improved compositions, systems, methods and techniques for processing and preparing cement, cement constituents and concrete formulations involving natural pozzolans. In various embodiments, the water demand, compressive strength, set times and workability in concrete incorporating certain natural pozzolans can be improved by blending with calcium carbonate powders, while further improvements can be accomplished if the calcium carbonate is inter-ground with the natural pozzolan to a desired and/or minimum fineness. This addition of calcium carbonate, fly ash, ground granulated blast furnace slag, ground glass and various acids to a natural pozzolan can desirably reduce water requirements and improve the physical performance characteristics of the natural pozzolan and the overall characteristics of the concrete. Various applications may allow for (1) extension of limited fly ash supplies in certain regions, (2) greater replacement of costly Portland cement, and/or (3) significant reductions of greenhouse gases resulting from Portland cement manufacture.

### CROSS-REFERENCE TO RELATED APPLICATIONS

This application is a continuation application of U.S. patent application Ser. No. 15/699,961 entitled “CEMENT FORMULATIONS AND METHODS,” filed Sep. 8, 2017, which in turn claims the benefit of U.S. Provisional Application No. 62/384,917 entitled “Supplemental Cementitious Material (SCM) Blends,” filed Sep. 8, 2016, and U.S. Provisional Application No. 62/531,179, entitled “Inter-Grinding of Cement Constituents,” filed Jul. 11, 2017, the disclosures of which are all incorporated by reference herein in their entireties.

### TECHNICAL FIELD

The present disclosure generally relates to improved compositions, systems, methods and techniques for processing and preparing cement, cement constituents and concrete formulations.

### BACKGROUND OF THE INVENTION

LASSENITE™ is a pozzolanic mineral substance mined from a deposit in Northern California. Lassenite was initially formed when volcanic ash fell into a fresh water lake which was rich in diatoms, a form of single celled microscopic plankton. Thousands of years of deposits of the skeletal diatoms and air-dropped volcanic ash, coupled with similar types of minerals being eroded into rivers and streams, eventually built up a significant layered mix of skeletal diatoms and volcanic ash on the bottoms of the shallow lake. In at least one unique instance, the average temperature of an ancient lake's waters was warm enough to support a continual bloom and demise of the diatoms. Lassenite contains an extremely high chemical concentration of amorphous silica and alumina oxides and a low concentration of metallic oxides.

A variety of pozzolanic materials have been previously incorporated into concrete formulations. In the ancient Mediterranean Basin, molten lava was flash frozen upon explosive expulsion from volcanic vents, instantly becoming what the Romans called “pozzolana”—pumice pozzolan, the key ingredient in Roman concrete. Roman structures such as aqueducts and the Pantheon used volcanic ash as pozzolan in their concrete. Concretes using natural pozzolan have proven to last thousands of years. It has been shown that pozzolans also fortify modern Portland cement based concrete, providing protection by mitigating various forms of chemical attack such as alkali-silica reaction (ASR), sulfate induced expansion, efflorescence, as well as rebar oxidation and debondment caused by the ingress of chlorides. Pozzolans also densify concrete, reducing porosity and permeability, thereby reducing chemical ingress and increasing long-term compressive strength and durability

While many different types of pozzolanic materials have been incorporated into concrete mixes, the use of natural pozzolans, including Lassenite, in this manner has heretofore been much less extensive. Consequently, there is a need for improved compositions, systems, methods and techniques for processing and preparing cement and concrete formulations incorporating Lassenite and/or similar natural pozzolanic materials.

### BRIEF SUMMARY OF THE INVENTION

In various embodiments, concrete formulations and processing techniques are provided in which Lassenite or similar pozzolanic materials form a constituent of the concrete mix. In some instances, the unique porous property of the Lassenite diatomite mineral, and its ability to integrate other cement constituents and/or liquids within and/or adjacent to the small capillaries throughout the mineral, provides a unique opportunity for processing techniques to create a cement formulation having greatly improved reactivity, workability and/or performance as compared to currently available cement mixes. Various embodiments disclosed herein include systems, devices, methods and procedures for combining, mixing, processing, layering and/or inter-grinding of various cements and/or cementitious constituents to improve the reactivity, processing and/or performance of the various mixes, constituents and/or components of cement, concrete and/or mortar. In various embodiments, natural pozzolans and calcium carbonate (and/or other constituent materials) can be inter-ground for use in cementitious blends for replacement of cement in concrete and mortars.

In various embodiments, a cement formulation comprising a natural pozzolan, such as Lassenite, can be combined with a source of calcium carbonate (such as limestone), with the combined mixture physically processed by various combinations of one or more of mixing, processing, layering and/or inter-grinding to produce a resulting mixture that can be combined with various other cement constituents such as Portland cement and/or fly ash to produce a resulting cement, concrete and/or mortar (1) having exceptional strength qualities early in the cure cycle, (2) having a reduced water demand as compared to traditional cement mixes and/or simple mixtures of the same constituent components, (3) that allows for reduction and/or elimination of various cement constituents such as fly ash, silica fume, metakaolin, grinding aids, water reducers and/or other additives, and/or (4) having significantly improved resistant to alkali-silica reaction (ASR) and/or other chemical and/or physical breakdown and/or degradation due to water/salt water. In various embodiments, the replacement of some and/or all of the Portland cement in a concrete mix can be facilitated and/or enabled, thereby potentially reducing greenhouse gas emissions and/or the carbon “footprint” associated with Portland cement production and/or use and can reduce the cost to produce concrete.

In various embodiments, component materials can be combined, milled and/or otherwise processed using virtually any contact, mixing, impact and/or pressure-based milling technology, including a variety of processing machinery such as grinding and/or milling of materials in ball mills (and other shape grinding media), roller mills (including vertical roller mills), vertical mills, millstones, roll presses, conical mills, impact mills, cutting mills and/or other mill types, which can include milling of the materials on a batch and/or continuous basis. While the description of blended cements discussed herein could allow for the intermixing of pozzolanic material(s) with other materials and/or finished Portland cement, in many of the disclosed methods of this invention, two or more of the various constituents of cement could be ground or otherwise physically processed together in a variety of proportions, using a variety of milling, compressing and/or grinding techniques and/or times.

In many embodiments, concrete mixes are disclosed that significantly improve the water demand characteristics and overall performance of a natural pozzolan used in concrete, which may include inter-grinding of the pozzolan with calcium carbonate. This inter-grind may then be utilized in concrete or mortars as produced or blended with other ingredients to make designed pozzolanic powders to efficiently replace cement and improve the physical and chemical characteristics of a given concrete mix.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings, in which:

FIG. 1 depicts an electron microscope image of ground Lassenite powder, showing both volcanic ash and diatom particles;

FIG. 2 depicts various test results of an extended milling of a 50/50 inter-grind of natural pozzolan and limestone;

FIG. 3 depicts a graph of various concrete mixtures created from samples of the inter-grind of FIG. 2, taken at various intervals;

FIG. 4 depicts various test results of various concrete mixes incorporating inter-ground and non-inter-ground constituents;

FIG. 5 depicts compressive strength results of the various concrete mixes of FIG. 4;

FIG. 6 depicts water demand characteristics of the various concrete mixes of FIG. 4;

FIG. 7 depicts various exemplary concrete mixes comparing calcium carbonate as a blend and an inter-grind constituent;

FIG. 8 depicts various exemplary concrete mixes created with a fixed amount of water in a ball mill;

FIG. 9 depicts various concrete mixes comprising constituents formed using two different formulations of inter-grinding, compared to a concrete mix comprising natural pozzolan without calcium carbonate;

FIG. 10 depicts various concrete mixes comprising various constituents and additives, including various proportions and combinations of natural pozzolans, calcium carbonate and fly ash;

FIG. 11 depicts various concrete mixes comprising various constituents and additives, including various proportions and combinations of inter-ground calcium carbonate and natural pozzolan that can be utilized with fly ash, slag cement and ground glass;

FIG. 12 depicts various concrete mixes comprising various constituents and additives, including various proportions and combinations of inter-grinds of calcium carbonates and natural pozzolans that can be blended with fly ash;

FIG. 13 depicts various concrete mixes comprising various constituents and additives, including various proportions and combinations of inter-grinds of calcium carbonates and natural pozzolans that can be blended with various fly ashes;

FIG. 14 depicts a chart of compressive strength versus replacement percentage for various different concrete mixes;

FIG. 15 depicts a chart of testing results comparing results of natural pozzolan mixed with Class F Fly Ash;

FIG. 16 depicts a chart of testing results comparing results of natural pozzolan mixing with Class F fly ash;

FIG. 17 depicts a chart of testing results comparing natural pozzolan mixed with Class F fly ash;

FIG. 18 depicts a chart of testing results including limestone dust added with natural pozzolan material and fly ash;

FIG. 19 depicts a chart of testing results incorporating hydrated lime;

FIG. 20 depicts a chart of testing results incorporating various natural pozzolan materials against fly ash controls;

FIG. 21 depicts a chart of testing results incorporating limestone dust as a SCM;

FIG. 22 depicts a chart testing results using limestone dust in various SCM designs;

FIG. 23 depicts a chart testing limestone dust with the addition of small amounts of acid;

FIG. 24 depicts a chart wherein shaded mix designs show improved water demand performance;

FIG. 25 depicts a chart of testing results for limestone dust with the inclusion of C Class fly ash;

FIG. 26 depicts a chart of testing results including a corrected Admix amount;

FIG. 27 depicts a chart of testing results for off-spec fly ash cement mix designs using several activators;

FIG. 28 depicts a chart of testing results for various particle sizes of three natural pozzolan samples having D50 diameters of 7, 17 and 22 microns;

FIG. 29 depicts a chart of testing results for ball-milled pozzolanic material with limestone dust and citric acid;

FIG. 30 depicts a chart of testing results for various mix ratios involving pozzolanic materials and limestone dust;

FIG. 31 depicts a chart of testing results including Inter-Grinding of concrete constituents;

FIG. 32 depicts a chart of testing results incorporating silica fume in concrete mixes;

FIG. 33 depicts another chart of testing results incorporating silica fume into concrete mixes;

FIG. 34 depicts a chart of testing results incorporating high silica fume replacement percentages in concrete mixes;

FIG. 35 depicts a chart of testing results incorporating various inter-grinds;

FIG. 36 depicts a chart of testing results incorporating constant pozzolan mass with increasing limestone mass;

FIG. 37 depicts a chart of testing results incorporating various grinding processes in cement mixes;

FIG. 38 depicts a chart of testing results incorporating various inter-grinds;

FIG. 39 depicts a chart of testing results of cement mixes incorporating replacement of inter-ground fly ash and natural pozzolan;

FIG. 40 depicts a chart of testing results of cement mixes incorporating replacement inter-grind fly ash, natural pozzolan and limestone dust;

FIG. 41 depicts a chart of testing results of cement mixes comparing blending of cement constituents versus inter-grinding of various constituents;

FIG. 42 depicts a chart of testing results of cement mixes incorporating constituents processed for various grind times including acid;

FIG. 43 depicts various particle size distribution curves for milled natural pozzolan;

FIG. 44 depicts a graph of particle size and water demand characteristics of inter-ground cement constituents; and

FIG. 45 depicts an exemplary aggregate size chart taken from ASTM C33.

### DETAILED DESCRIPTION OF THE INVENTION

Certain embodiments of the present disclosure will now be further described in more detail, in a manner that enables the claimed invention to be understood so that a person of ordinary skill in this art can make use of the present disclosure. Unless otherwise indicated, all numbers expressing reaction conditions, concentrations, yields, and so forth used in the specification and claims are to be understood as being modified in all instances by the term “about.” Accordingly, unless indicated to the contrary, the numerical parameters set forth in the following specification and attached claims are approximations that may vary depending at least upon the specific analytical technique. Any numerical value inherently contains certain errors necessarily resulting from the standard deviation found in its respective testing measurements.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this disclosure belongs. If a definition set forth in this section is contrary to or otherwise inconsistent with a definition set forth in patents, published patent applications, and other publications that are incorporated by reference, the definition set forth in this specification prevails over the definition that is incorporated herein by reference.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of excludes any element, step, or ingredient not specified in the claim. When the phrase” consists of (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms are used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of.”

Various aspects of the present invention include cement formulations comprising pozzolanic materials, as well as formulations comprising non-pozzolanic materials, and processing methods and/or techniques thereof. In at least one exemplary embodiment, two or more components of a cement mixture are co-processed prior to mixture and/or blending with any remaining cement components, leading to an unexpected improvement in the quality, workability and ultimate performance of the cement when poured. In some variations, one of the two cement constituents comprise a pozzolanic material such as Lassenite, while the other constituent may comprise calcium carbonate (i.e., limestone) in aggregate form, with the two constituents inter-ground, pulverized and/or otherwise combined and/or “fused” in a horizontal ball mill or other comminution equipment. Once the resulting powder mixture has reached a desired consistency, it is removed from the mill and combined or mixed with the remaining cement constituents. The finished cement mix can then be hydrated and poured in a standard manner.

The products of this invention will be useful in preparing cementitious compositions such as hydraulic cements, mortars, or concrete mixes which include concretes, mortars, neat paste compositions, oil well cement slurries, grouting compositions and the like. Cementitious compositions, Portland cements and/or blended Portland cements are well known and are described in “Cement”, Encyclopedia of Chemical Technology. (Kirk-Othmer, eds, John Wiley & Sons, Inc., N Y N Y, 4th ed, 1993), vol 5, pp 564-598, the disclosure of which is incorporated by reference herein. Portland cement is by far the most widely used hydraulic cement. The term “hydraulic cement” as used herein includes those inorganic cements which, when mixed with water, set and harden as a result of chemical reactions between the water and the compounds present in the cement.

The term cement can be used broadly to designate many different kinds of agents useful to bind materials together, including hydraulic cements useful to form structural elements, such as those of roads, bridges, buildings and the like. Hydraulic cements can comprise powder material which, when mixed with water, alone or with aggregate, form rock-hard products, such as paste, mortar or concrete. Paste can be formed by mixing water with a hydraulic cement. Mortar can be formed by mixing a hydraulic cement with small aggregate (e.g., sand) and water. Concrete can be formed by mixing a hydraulic cement with small aggregate, large aggregate (e.g., 0.2 inch to 1 inch or greater stone) and water. In one example, Portland cement is a commonly used hydraulic cement material with particular standard specifications established in the various countries of the world. Further, various organizations, such as American Society for Testing and Materials (ASTM), American Association of State Highway and Transportation Officials, as well as other governmental agencies, have established certain minimum standards for hydraulic cements which are based on principal chemical composition requirements of the clinker used to form the cement powder and principal physical property requirements of the final cement mix.

ASTM C 618, Standard Specification for Fly Ash and Raw or Calcined Natural Pozzolan for Use as a Mineral Admixture in Portland Cement Concrete, provides additional details concerning the chemical and physical properties of pozzolans and fly ashes. ASTM C 618 is hereby incorporated by reference in its entirety. The materials comprised within the specifications of ASTM C 618 are divided into three classes. Class N comprises raw or calcined natural pozzolans such as some diatomaceous earths, opaline cherts and shales, tuffs and volcanic ashes or pumicites, and various materials requiring calcination to induce satisfactory properties (such as some clays and shales). Class F comprises fly ash normally produced from burning anthracite or bituminous coal. Class C comprises fly ash normally produced from lignite or subbituminous coal; in addition to having pozzolanic properties, this class of fly ash also has some cementitious properties. For purposes of the present invention, all three classes of materials defined in ASTM C 618 are considered potentially suitable for use in preparation of blended Portland cements meeting the requirements of ASTM C 595; therefore, a Type IP or Type 1(PM) blended Portland cement for purposes of the present invention may comprise Class N, Class F and/or Class C materials in addition to the Portland cement. Type 1(SM) cement is an intimate and uniform blend of Portland cement and fine granulated blast furnace slag produced by inter-grinding Portland cement clinker and granulated blast-furnace slag, by blending Portland cement and finely ground granulated blast-furnace slag, or a combination of inter-grinding and blending in which the slag constituent is less than 25% of the weight of the slag-modified Portland cement. Type IS an intimate and uniform blend of Portland cement and fine granulated blast-furnace slag in which the slag constituent is between 25 and 70% of the weight of Portland blast-furnace slag cement. Blast-furnace slag is a nonmetallic product consisting essentially of silicates and aluminosilicates of calcium and other bases. Granulated slag is the glassy or non-crystalline product which is formed when molten blast furnace slag is rapidly chilled, as by immersion in water. ASTM C 989, Standard Specification for Ground Granulated Blast-Furnace Slag for Use in Concrete and Mortars, provides additional details concerning the chemical and physical properties of blast furnace slags. ASTM C 989 is hereby incorporated by reference in its entirety.

In various embodiments, two or more component materials of a cement mix can be combined, milled, fused and/or otherwise processed using a proper combination and processing via virtually any comminution technology, including a variety of processing machinery such as grinding and/or milling of materials in ball mills (and other shape grinding media), roller mills (including vertical roller mills), vertical mills, millstones, roll presses, conical mills, impact mills, cutting mills and/or other mill types, which can include milling of the materials on a batch and/or continuous basis. In some of the present embodiments, ball-type processing mills and/or similar processing equipment may be preferred to varying degrees, in that this type of processing may be capable of sufficiently processing a first cement constituent to a desired degree without causing significant disruption to one of more desired characteristics of a second cement constituent which has been admixed with the first cement constituent prior to undergoing such processing.

In various alternative embodiments, the natural pozzolan and calcium carbonate could be milled separately to produce powders of various particle sizes, and then combined together using blenders or mixers or other devices, including ribbon blenders, pug mills, conical mixers, rotary misers, or virtually any other type of equipment that will desirably produce a homogenous blend of the component materials.

In at least one exemplary embodiment, a cement formulation can be created that greatly improves the water demand characteristics and overall performance of a natural pozzolan (such as Lassenite) used in concrete, such as by inter-grinding the pozzolan with calcium carbonate and/or other materials. This inter-ground material may then be utilized in concrete or mortars as produced or blended with other ingredients to make designed pozzolanic powders to efficiently replace cement and improve concrete physical and chemical characteristics.

There are two classifications for calcium carbonate as defined in ASTM 1797-16 (incorporated by reference herein), Type A and Type B. Either classification can be used in inter-grinds with a natural pozzolan to reduce water demand in concrete and mortar mixes, but the higher CACO3 content of the Type A may be more beneficial in concrete properties such as compressive strength for some embodiments herein. In various alternative embodiments, other mineral fillers or other sources containing calcium carbonate could be employed with varying utility.

### Definitions

The American Concrete Institute (ACI) provides the following definitions, that are incorporated herein by reference in this disclosure:

Pozzolan—a siliceous or siliceous and aluminous material that, in itself, possesses little or no cementitious value but that will, in finely divided form and in the presence of moisture, chemically react with calcium hydroxide at ordinary temperatures to form compounds having cementitious properties; there are both natural and artificial pozzolans.

Pozzolan, artificial—man-made materials having pozzolanic properties, such as fly ash and silica fume.

Pozzolan, natural—a raw or calcined natural material that has pozzolanic properties, including (but not limited to) volcanic tuffs or pumicites, opaline cherts and shales, clays, and diatomaceous earths.

The American Society for Testing and Materials (ASTM International) also provides similar definitions, that are incorporated herein by reference in this disclosure:

Pozzolan—a siliceous or siliceous and aluminous material that in itself possesses little or no cementitious value but will, in finely divided form and in the presence of water, chemically react with calcium hydroxide at ordinary temperatures to form compounds possessing cementitious properties.

Pozzolan, natural—a raw or calcined naturally occurring material that behaves as a pozzolan—Examples of natural pozzolans include volcanic ash, tuff, pumicite, opaline chert, opaline shale, metakaolin, and diatomaceous earth.

To best understand the nature and use of natural and/or artificial pozzolans, it helps to understand the basic principles underlying concrete technology. Concrete is, in its most basic form, a paste (cement and water) and aggregates (rock and sand), which is plastic and malleable when newly mixed and strong and durable when hardened. While many people interchange the words “cement” and “concrete,” this comparison may not be truly accurate, and is a little like interchanging the words “flour” and “cake.” In essence, “cement” is the powder that reacts with water to form the paste or glue (calcium silicate hydrates or CSH) that binds everything in the concrete together. “Portland” cement, the primary portion of paste in modern concrete, is made by heating limestone and other minerals to very high temperatures, then grinding this mix into a fine powder. Unfortunately for the environment and environmental regulation, this required high heat reaction from Portland cement production produces a carbon-dioxide or CO₂ byproduct, resulting from the fuel burned for heating as well as various chemical reactions that occur in/with the limestone during this process. Although the exact amount of CO₂ produced varies from cement plant to cement plant, it is generally accepted that every ton of cement manufactured creates about a ton of CO₂ emissions byproducts. In fact, it has been estimated that from 5% to 8% of current man-made global CO₂ emissions are from the worldwide manufacture of Portland cements alone.

Modern concrete also typically contains a variety of admixtures and Supplementary Cementitious Materials (SCM), to desirably improve its properties in a variety of ways, with the most widely used SCMs desirably functioning primarily as pozzolans in the concrete. When water and Portland cement are mixed and react, this reaction also forms calcium hydroxide or Ca(OH)₂ as a byproduct. However, because the presence of free Ca(OH)₂ in concrete can be significantly detrimental to the concrete's long term strength and permeability, the supplemental SCMs desirably react with the Ca(OH)₂ byproduct to form more Calcium Silica Hydrate (CSH) “glue” in the concrete.

Two of the most common pozzolanic SCMs that are added to concrete are fly ash and ground granulated Blast Furnace Slag (GGBFS—also called slag cement). Fly ash, also known as “pulverized fuel ash” in the United Kingdom, is a coal combustion product composed of fine particles that are driven out of the boiler with the flue gases, and which is typically recovered by the air pollution control systems (i.e., electrostatic precipitators or other particle filtration equipment) before the flue gases reach the chimneys of coal-burning power plants. Depending upon the source and makeup of the coal being burned, the components of fly ash vary considerably, but all fly ash includes substantial amounts of silicon dioxide (SiO2) (both amorphous and crystalline), aluminum oxide (Al₂O₃) and calcium oxide (CaO), the main mineral compounds in coal-bearing rock strata. Two classes of fly ash are defined by ASTM C618: Class F fly ash and Class C fly ash. The chief difference between these classes is the amount of calcium, silica, alumina, and iron content in the ash. The chemical properties of the fly ash are largely influenced by the chemical content of the coal burned (i.e., anthracite, bituminous, and lignite). Fly ash often replaces some of the Portland cement, and its addition to the cement mix desirably improves the workability and permeability of the concrete without a significant loss of strength.

Slag Cement (Ground Granulated Blast-Furnace Slag or GGBS) is a nonmetallic byproduct developed during iron production in a blast furnace, which is obtained by quenching molten iron slag (a by-product of iron and steel-making) from a blast furnace in water or steam, to produce a glassy, granular product that is then dried and ground into a fine powder. The main components of blast furnace slag are CaO (30-50%), SiO₂ (28-38%), Al₂O₃ (8-24%), and MgO (1-18%). The glass (amorphous) content of slags suitable for blending with Portland cement typically varies between 90-100%, and often depends on the cooling method and the temperature at which cooling is initiated. The glass structure of the quenched glass largely depends on the proportions of network-forming elements such as Si and Al over network-modifiers such as Ca, Mg and to a lesser extent Al. When ground as fine or finer than cement the slag cement particles, like fly ash, react with the Ca(OH)2 in the concrete to form more CSH “glue.” The use of GGBS can significantly reduce the risk of damages caused by alkali-silica reactions (ASR), may provide higher resistance to chloride ingress (i.e., reducing the risk of reinforcement corrosion) and may provide higher resistance to attacks by sulfate and/or other chemicals. However, concrete made with GGBS cement typically sets more slowly than concrete made with ordinary Portland cement, depending on the amount of GGBS in the cementitious material, but this concrete also continues to gain strength over a longer period in production conditions. This results in lower heat of hydration and lower temperature rises, and makes avoiding cold joints easier, but may also affect construction schedules where quick setting is required.

Other, more expensive SCMs that can be added to concretes include silica fume and meta-kaolin. Because of the relatively high costs of these materials, however, these products are typically used only in very special mixes in which high early strength or very low permeability is required.

The oldest known SCMs are natural pozzolans, typically volcanic ashes and similar non-crystalline minerals. These products are naturally occurring and were successfully used by the Romans thousands of years ago to create concrete structures like the Coliseum and the Pantheon. Still structurally stable almost two thousand years after it was built, the Pantheon's dome remains the world's largest unreinforced concrete dome. The addition of fly ashes to concrete functions in a similar manner to natural pozzolans, and since the mid-20th Century fly ash has largely replaced natural pozzolans in the United States because of its availability and very low cost. However, market dynamics are changing the quality and availability of fly ash, and many factors are improving the rise in popularity of natural pozzolans for use in concretes.

The reduction of cement content in concrete is one of the persistent global sustainability concerns of the 21st century. Of all the ingredients in concrete (the primary ones being cement, supplementary cementitious materials, water, and coarse and fine aggregates), Portland cement has the largest footprint when it comes to both carbon dioxide release and energy consumption. While the feasibility of achieving higher levels of cement replacement using fly ash has been demonstrated, questions remain about the stability of the supply of quality fly ash and local shortages have indeed been encountered in parts of the U.S. in recent years. Similarly, high replacement mixtures using slag have demonstrated good performance, but the worldwide slag supply is quite limited when compared to the annual demand for concrete for new construction and repair.

In designing a concrete mix, many different properties of the concrete and its constituent materials are typically considered and balanced. The most basic property of concrete is the concrete's compressive strength under load, which is largely a function of the water to cement ratio (w/c) used in mixing the concrete to be set, and properties of the aggregate. Increasing the amount of cement and/or reducing the amount of water for a given set of materials generally increases the compressive strength of the concrete, but water reduction can also adversely affect the pumpability or pourability (i.e., flowability) of the hydrated concrete. The addition of fly ash pozzolans may help reduce the required water demand or w/c ratio (because of their spherical bead shape), while the addition of natural pozzolans may often increase the water demand. Water reducer additives or blending pozzolans in certain ways may alleviate the increased water demand. There are also other measures of strength (e.g., flexural and tensile) which are occasionally more important in design than compressive strength. Like compressive strength, they are typically a function of the w/c ratio.

Most concrete strengths are specified at 28 days, but for many applications suppliers want to meet the strength goal within 7 days to speed up construction. Larger mass structures typically will be specified for 56 days or longer to reduce the heat buildup that would cause cracking. Some fly ash and natural pozzolans react more slowly than Portland cement, while silica fume typically reacts faster.

There are many more properties of concrete which can become important in certain environments and structural applications, including: alkali-silica reactivity (ASR), efflorescence, freeze/thaw resistance, lightweight/heavy weight, sulfate resistance, low heat of hydration (in mass concrete), and shrinkage. Engineers design the concrete mix to desirably provide the best characteristics for the lowest cost. Pozzolans can improve concrete performance in many of these areas by reacting with unwanted compounds and making the concrete stronger, less permeable, or more dense; resist cracking; or by delaying the chemical reactions to reduce heat. A few natural pozzolans are available for use in concrete mixtures, but a large proportion of these pozzolans have increased water demand characteristics in concrete which may require special and/or expensive treatments and/or additives to achieve successful results.

In view of the water demand issue and related limitations posed by the addition of natural pozzolans to concrete mixes, as well as the predicted decline in fly ash availability for a variety of reasons, it is desirous to develop a cost-effective method of reducing the water demand of concrete and mortar mixes containing natural pozzolans.

As part of Applicant's disclosures herein, it has been discovered that inter-grinding and/or other processing of a calcium carbonate source in combination with or on the presence of a natural pozzolan, such as Lassenite, to a proper fineness can greatly enhance the pozzolan/calcium carbonate mixture by reducing its water demand in concrete and mortar mixes. It has been further discovered that calcium carbonate and the natural pozzolan can be ground separately and blended in a variety of ways to achieve various improved results over existing concrete and/or mortar mixes incorporating natural pozzolans.

In various embodiments, the disclosed natural pozzolan/calcium carbonate blends can be used alone or be furthered blended with other certified pozzolans or other materials to extend current supplies or to improve certain characteristics of the SCM blend(s). The teachings of the present disclosure may alternatively be used to facilitate the remediation of poor-quality and/or non-certifiable natural pozzolans, including by reducing its water demand, that will allow the modified natural pozzolan to fulfill maximum water requirements for specifications like ASTM C618 or AASHTO M295 (both of which are incorporated by reference herein). The systems and methods herein may also facilitate the long-term availability of fly ash and other limited pozzolans, which may be needed to produce economically viable, durable, and chemically resistant concrete now and in the future.

In various embodiments, the teachings of the current disclosure may be utilized by cement companies and/or other producers to produce a “1P cement.” 1P cements are cement mixes that have been altered by the addition of a pozzolanic material to desirably provide pozzolanic advantages to the concrete or mortar in which it is mixed. Desired pozzolanic qualities for such cement mixes include, but are not limited to, mitigating one form of chemical attack or another, such as alkali-silica reactions (ASR), alkali-sulfate reactions and the damaging effects of chloride egress, particularly the oxidation and/or debonding of reinforcing steel; concrete densification and impermeability enhancement, increased long-term compressive strength, and mitigation of efflorescence.

In some embodiments, disclosed are pozzolanic compositions for use in concrete and mortars, the compositions comprising calcium carbonate combined with a natural pozzolan by either inter-grinding or blending. In some embodiments, the calcium carbonate is inter-ground with a natural pozzolan to a fine powder with mean particle size (D50—where 50% of the particles are less than the specified size) of less than 10 microns. In some embodiments, the calcium carbonate and natural pozzolan are separately ground to a fineness less than 20 microns (D50) and/or 25 microns (D50) and then blended. In some embodiments, the calcium carbonate is present in concentrations of about 1 wt % to about 99 wt %, such as 10 wt % to 60 wt %, 15 wt % to 50 wt %, 20 wt % to 50 wt %, 25 wt to 50 wt %, 30 wt % to 50 wt %, 35 wt % to 50 wt %, 40 wt % to 50 wt %, 45 wt % to 50 wt %, 49 wt % to 50 wt % and/or 50 wt % to 99 wt %. In some embodiments, a natural pozzolan may have requirements of certain minimum concentrations of certain chemicals, wherein the calcium carbonate addition may dilute these concentrations to varying degrees and potentially place “limits” on the wt % of calcium carbonate that can be used in various cement mixes.

The natural pozzolans disclosed for use in the various embodiments herein may comprise a pozzolanic volcanic ash, such as (but not limited to) a pozzolan derived from tephra, tuff, pumicate, or pumice or perlite. In some embodiments, the natural pozzolan may be selected from the group consisting of pumice, perlite, metakaolin, diatomaceous earth, ignimbrites, calcined shale, calcined clay, and combinations both natural form or blended. In some embodiments, the natural pozzolan comes from a Long Valley, Calif. quarry and may be marketed under the trademarked name Lassenite™ and/or may comprise materials of similar chemical constituents. In some embodiments, the natural pozzolan/calcium carbonate mixture may be further blended with other “by-product” pozzolans (including man-made pozzolans) such as fly ash (type F and/or Type C), silica fume, ground glass, and ground granulated blast furnace slag to provide an enhanced SCM product.

In various embodiments, a method of producing a pozzolanic composition for use in concrete and mortars is disclosed, the method comprising: providing a source of one or more natural pozzolans; providing a source of calcium carbonate; and combining the natural pozzolan and calcium carbonate and inter-grinding the combined pozzolan and calcium carbonate source to a sufficient degree to produce a pozzolanic composition which has reduced water demand characteristics in concrete as compared to the use of the same natural pozzolan by itself in concrete.

In another exemplary embodiment, a method of producing a pozzolanic composition for use in concrete and mortar is disclosed, the method comprising utilizing an inter-ground blend of a natural pozzolan and calcium carbonate, blended with one or more of the following: an ASTM certified C 618 pozzolan, type F, C or N; a ground glass; a ground granulated blast furnace slag (GGBFS or slag cement); and/or silica fume.

In various embodiments, the pozzolanic material may comprise a man-made pozzolanic material, which may be blended with other pozzolans and inter-ground with limestone and/or other constituents as described herein, In various alternative embodiments, the pozzolanic material may comprise a man-made pozzolanic material which is inter-ground with limestone and/or other constituents as described herein.

Processing by Inter-Grinding

Applicant has discovered that inter-grinding and/or other physical processing of various concrete constituents, in various combinations, can be utilized to create a combined constituent that is significantly more effective in concrete mixes than the use of a particular constituent alone or than the simple combining, blending and/or mixing of the constituents alone (i.e., using traditional cement blending or mixing methods). In various embodiments, inter-grinding is believed to accomplish one or more of the following: (1) to break down various physical structures of the natural pozzolans or other constituent materials to a form more conducive to cement formation (i.e., to “break down” the diatomaceous form and/or shape of Lassenite, or “crack open” or otherwise pulverize closed structures of various materials), (2) to overcome electrostatic attractive and/or repulsive forces between the various constituent materials, (3) to physically “pack” or compress one constituent into and/or with various amounts of other constituents (e.g., to physically “fill” diatom shapes and/or crevices therein with calcium carbonate or other particles and/or “particle pack” the constituents together) and/or (4) to increase the surface area of some or all of the particles of the various constituent materials, such as by “scratching” the surface of a particle to desirably increase the overall surface area of and reactivity of the particle (but desirably without destroying the generally spherical or other shapes of some of the constituent particles, such as fly ash, for example).

The process by which the various disclosed constituents and/or other materials are bound together may be by any suitable means, including mechanical milling, which we have found to be particularly flexible and efficient, as it provides a means of adjusting both the median size and size distribution of the resulting particles (if such be necessary) and results in some or all of the various materials becoming securely bonded together. The expression “mechanical mill” is to be understood to include ball mills, nutating mills, tower mills, planetary mills, vibratory mills, attrition mills, gravity dependent type ball mills, jet mills, rod mills, high pressure grinding mills and the like. By way of example, a ball mill is a vessel that contains grinding media that are kept in a state of continuous relative motion by input of mechanical energy. The grinding media are typically steel or ceramic balls. Sufficient energy is imparted to the particles within a ball mill by ball-particle-ball and ball-particle-mill collisions to cause attrition of the various components, including attrition and/or abrasion of the various particles therein as well as bonding of the pozzolan to the various constituents. Without wishing to be bound by theory, we believe that the preferred nature of bonding is physical rather than chemical or electrical, and this enables the various mixture components to combine and/or release more effectively when dispersed in the cementitious composition.

It is to be understood that normally not all the inter-ground components may be fully bonded to the pozzolan or other material(s) by the above processes, and various minor and/or major amounts of the cement components may be loosely dispersed therein. In various embodiments, a range of constituent materials can be can be milled with a range of natural pozzolans in an attritor mill within the preferred operating parameters described herein, which can desirably reduce the median particle size of one of more constituents and/or the pozzolanic material(s), including adjusting particle size distribution so as to be approximately normal and relatively broad and/or dilute the various cement components within the mix and/or bond various components together. Desirably, the disclosed processes can result in uniform coating of some individual pozzolanic particles and/or particles of the various constituents being lodged in the surface of some agglomerates and/or particles of the various constituents attached to some individual pozzolan particles in some cases.

In various embodiments, the inter-grinding techniques disclosed herein can be utilized to thoroughly and/or uniformly “mix” and/or distribute one or more constituent materials and/or additives into a given second material and/or cement mix, which can include compaction and/or “cold welding” of the various materials/constituents during the processing phase. Desirably, the resulting mix can comprise a pozzolanic material wherein one or more constituents can be “packed into” and/or physically welded to the interior and/or surface of the pozzolanic material. In various embodiments, the particles of the one or more constituents can be larger than and/or approximate the size of the pozzolanic material particles, while in other embodiments the one or more constituents can have a median particle size of between one tenth and one half, or more preferably one tenth to one third of the median particle size of the pozzolanic material. The disclosed methods of inter-grinding desirably places constituents in the cement mix where they are most effective, thus increasing the reactivity of the various constituents and reducing the risk of such constituents being wasted and/or causing unwanted effects on the general cement hydration process. The disclosed methods may be used in a variety of ways to influence all or any of, the rheological properties of the fresh paste, the hydration reaction, the pozzolanic reaction and/or the properties of the hardened concrete.

In various embodiments, the inter-grinding of a natural pozzolan (i.e., Lassenite) in combination with a limestone material can result in a processed mixture that, when added to a cement mixture can significantly increase the workability/pumpability of the mixture and/or greatly reduce the water demand in the cement mixture, which can concurrently reduce the need for fly ash and/or water reduction additives in the cement mix and/or greatly increase the early set strength of the cement. In various embodiments, the inter-grinding of various cement components can significantly reduce “shrinkage” of the resulting engineering structures created by setting and curing of the disclosed cement mixtures.

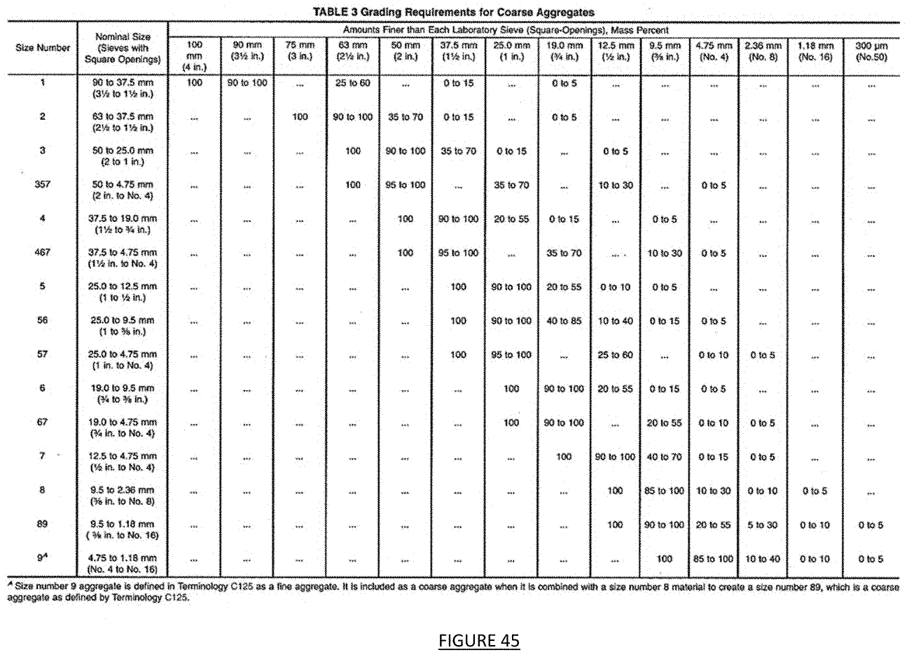

Applicant has also discovered that various of the inter-grinding methods and techniques described herein can be accomplished using a natural pozzolan such as Lassenite in combination with a relatively larger size of aggregate limestone or other calcium carbonate source, which can greatly simplify the storage, transport and utilization of the various components of the cement mix prior to inter-grinding. In various embodiments, the limestone source could comprise a coarse or fine limestone sand, or could comprise a relatively larger limestone aggregate, including aggregates sizes approximate and/or equal to 4″, 3.5″ 3″ 2.5″ 2″, 1.5″, 1″, 0.75″, 0.5″, 0.375″, #4, #8, #10, #16, #20, #30, #40, #50, #100, #200 (and/or any combinations of ranges therebetween, such as between 3″ and 0.375″, for example), as well as aggregate sizes and size ranges described in ASTM C33—the disclosure of which is incorporated herein by reference, with an example chart being depicted in FIG. 45.

Currently, where limestone is intended to be a component of a supplementary cementitious material mix, the limestone rock is first processed to a fine particle or “dust” form before being combined with the other cement constituent(s). Because limestone powder is often a byproduct of the crushing of larger limestone aggregates, limestone powder is most often obtained from a commercial aggregate production plant, supplied as the dust of fracture and captured and sized using various filters and related devices at the plant. Once created, the limestone dust must be shipped in enclosed transport such as a closed truck or rail car, as the dust is easily disturbed and readily becomes airborne. Loading and unloading of such dust may require special handling and protective equipment, and it can take over an hour for a truck or railcar to be loaded and/or unloaded with the fine limestone particulate. While limestone dust could potentially be manufactured and/or blended “on-site” at a concrete batch plant, such on-site manufacture is somewhat rare and adds significant additional expense to the manufacturing process to accommodate the required processing, safety equipment and trained personnel, and on-site manufacture would also add an additional step (and require additional time) in the concrete production process.

In contrast, Applicant's disclosed methods provide for a limestone aggregate to be co-processed with a natural pozzolan such as Lassenite. The calcium carbonate source can comprise a limestone aggregate of up to 2 or greater inches in diameter, which can be easily transported by truck or train with no special powder handling equipment and/or safety precautions, quickly loaded and/or unloaded using standard techniques, and stored “on-site” at the cement manufacturing facility in a simple pile storage facility. When required, the limestone aggregate can be loaded into a standard ball mill with the other constituent(s), and then the ball mill operated at a desired speed and for a desired duration to inter-grind the limestone and natural pozzolan to a desired fineness. Once inter-grinding is completed, the limestone/pozzolan mixture can be combined with the remaining concrete constituents, and the cement is ready for shipment and/or use. By obviating the need for pre-processing, handling and/or storage of the extremely fine limestone dust suggested by the prior art, the present methods significantly reduce many of the costs and the time to manufacture of the disclosed concrete mixtures.

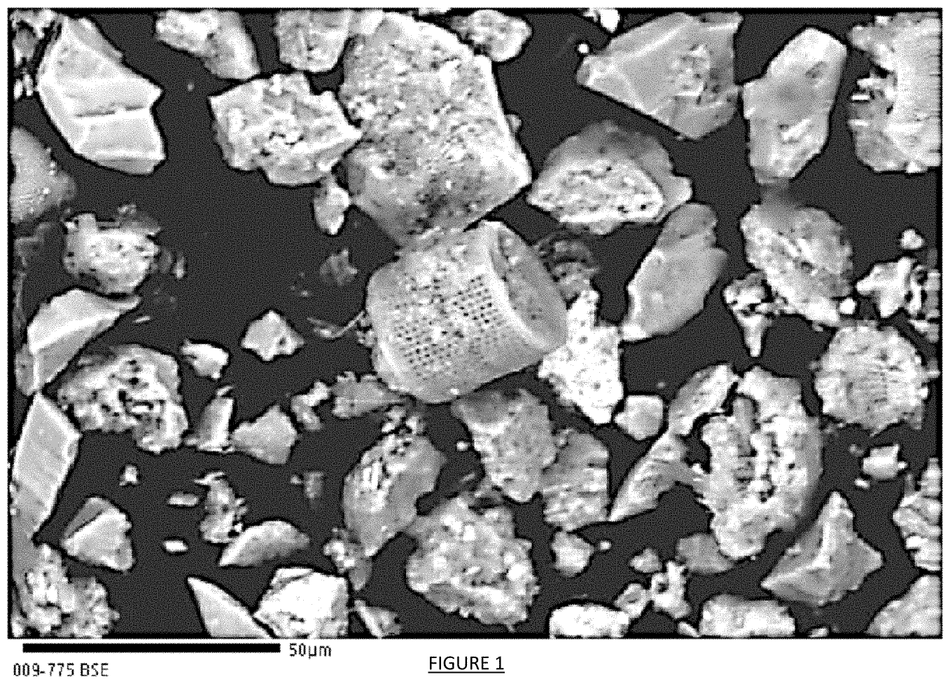

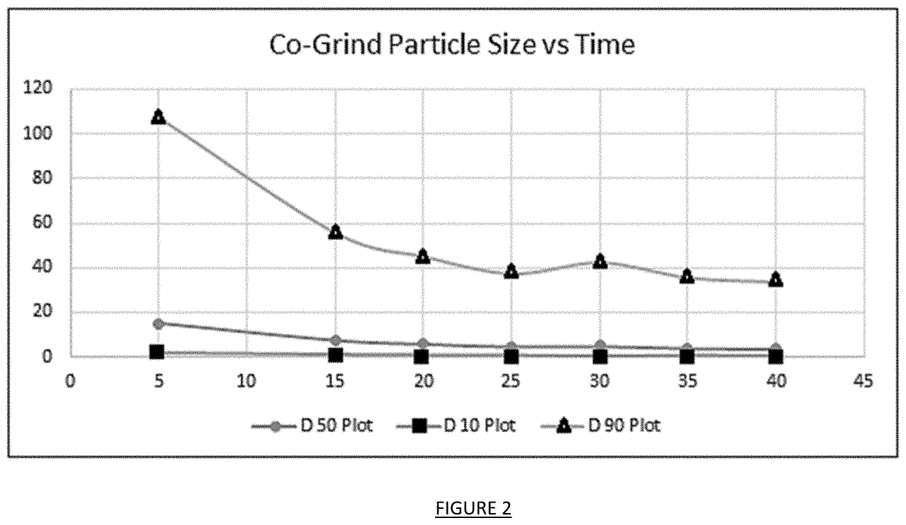

FIG. 2 depicts various test results of an extended milling time test of a 50/50 inter-grind of natural pozzolan (Lassenite™—see FIG. 1) and limestone (i.e., calcium carbonate). The mill type utilized in this test was a lab ball-type mill, which was useful for modelling large scale ball-type mill processing of concrete formulations and constituents thereof. As can be seen from FIG. 2, as the milling time is increased, the median particle size of the inter-ground powder decreased.

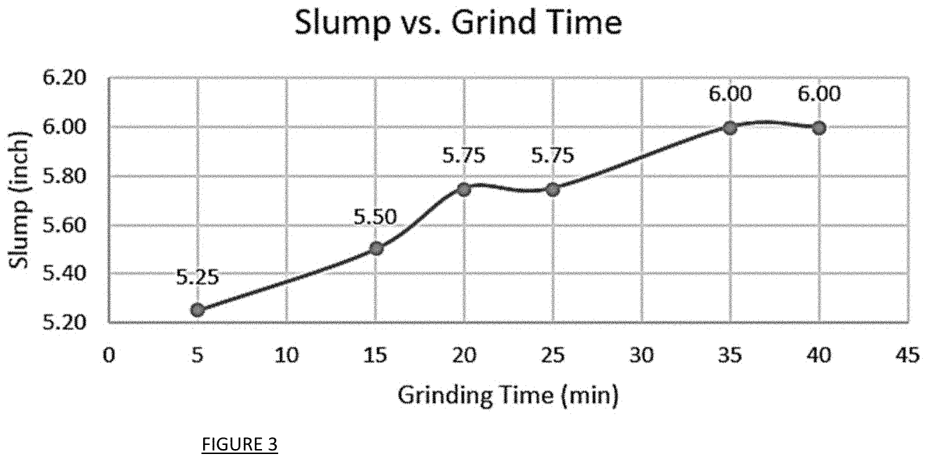

FIG. 3 depicts a series of concrete mixtures that were created by sampling the prior inter-grind of FIG. 2 at various intervals, with the samples then mixed with 2 parts fly ash in a concrete mix at a fixed water content. Slump, which is a measure of the consistency of the concrete, was determined for each of these concrete mixes, with higher slumps at the same water content typically indicating a decrease in the water demand for the concrete mix.

Applicant believes that concrete utilizing various inter-ground blends of various concrete constituents, including the disclosed SCMs, will significantly improve the concrete's workability, strength, and general overall performance, while experiencing a significantly lower water demand compared to use of the natural pozzolan alone. In Applicant's prior research, Applicant used fly ash and calcium carbonate powders to reduce water demands in various concrete blends. However, with Applicant's new discovery of improved water reduction from inter-grinding of calcium carbonate and a natural pozzolan, Applicant has determined that less fly ash would be required in various SCM blends utilizing such co-processed materials, and Applicant further believes that fly ash could even be removed completely from various concrete blends without causing large increases in water demand and/or causing significant reductions in the physical properties of the resulting concrete. Applicant has also discovered that some concrete mix ingredients, such as fly ash and limestone dust, contribute significantly improved properties to the blends when inter-ground with the natural pozzolan and/or other concrete constituents.

It should be understood that the use of the inter-grinding and/or other co-processing techniques for various combinations of the cement and/or concrete constituents is specifically contemplated for use in some or all of the embodiments described herein. In addition, any combination or sub-combination of constituents could be subject to such co-processing, including the co-processing of two or more constituents of a concrete mix for an entire processing activity (i.e., inter-grinding of calcium carbonate and Lassenite for 55 or more minutes in a ball mill) as well as partial inter-grinds (i.e., adding one or more concrete constituents to a currently active process, such as grinding calcium carbonate for 30 minutes and then adding a natural pozzolan to the ground calcium carbonate so as to continue inter-grinding of the two constituents for another 25 minutes).

In various embodiments, inter-grinding of a slag product with limestone dust can produce a similar increase in the workability and/or strength of the cement produced, and a commensurate increase in slump of the cement mix.

In various embodiments, ground glass or similar materials can be utilized as an additive to a blend which is subsequently inter-ground. In a similar manner, virtually any combination of cement constituents, including those various formulations described herein, can be processed and/or inter-ground in a similar manner, and then combined in a variety of ways (including further inter-grinding with other constituents, if desired) with remaining constituents to create a cement mix.

It is contemplated that the disclosed inter-grinding and/or other processing techniques could be utilized with equal utility with the various formulations and/or mixes (and disclosures thereof) described herein, including the use of inter-grinding techniques to process two or more of the various constituents of the supplemental cementitious material mixes disclosed herein.

In various of the Examples and exemplary formulations descried herein, a wide variety of pozzolanic compositions comprising various inter-ground blends of natural pozzolans and calcium carbonate and/or other materials were evaluated experimentally for use in cementitious materials. Furthermore, these inter-ground combinations and some blended combinations of natural pozzolan and calcium carbonate were experimentally evaluated with other pozzolans, slag cement, and ground glass.

Different cements were evaluated with the pozzolan compositions, but the bulk of the research was performed on a Type I/II cement. Different weight percent replacement of cement with pozzolan compositions were performed, but the majority of the research was at 25% replacement of cement. Different overall cementitious contents were evaluated, but the majority of the research focused on 660 lbs total cementitious contents in the concrete mix designs

In general, the compressive strength testing was performed using 2 by 2 inch mortar cubes fabricated by mini mix lab procedures. Concrete mixes were proportioned such that 1 pound in the mix design equaled 1 gram in the mini mix, and the stone was removed from the mix design. A sand absorption cone was used as a mini slump cone, and the mini slump was multiplied by 4 to equate to a regular slump. Dry sand was used for the standard and the water absorption was adjusted based on the sand used. Water that was added to the mix was measured in grams, and standard ASTM C109 (which is incorporated herein by reference) procedures were used for mixing.

When performing set time testing, the ASTM C403 Standard Test Method for Time of Setting Concrete Mixtures by Penetration Resistance (incorporated herein by reference) was used. The concrete was placed in cylinder molds and penetrated with a needle to determine the resistance from the concrete. This procedure was repeated until a penetration resistance of 500 psi was reached.

These testing procedures allowed for rapid evaluation of different pozzolanic compositions with very little waste as opposed to full scale concrete tests. Some full-scale concrete testing was performed to verify the mini mix modeling was accurate in concrete.

In various embodiments, the particle size distribution of the natural pozzolan, limestone, and/or slag can often be important to achieve high surface area for reaction sites and greater pozzolanic activity, wherein finer particle size creates greater surface area. Natural pozzolans may be mined with inherent moisture that potentially impacts performance of material handling and comminution equipment.

If desired, natural pozzolans such as Lassenite may be mined and partially ground on-site and dispersed over an area for air and/or solar drying, potentially reducing the ultimate cost of drying the pozzolan during the manufacturing processes. Such an approach can be particularly useful where the pozzolan is mined in an arid climate.

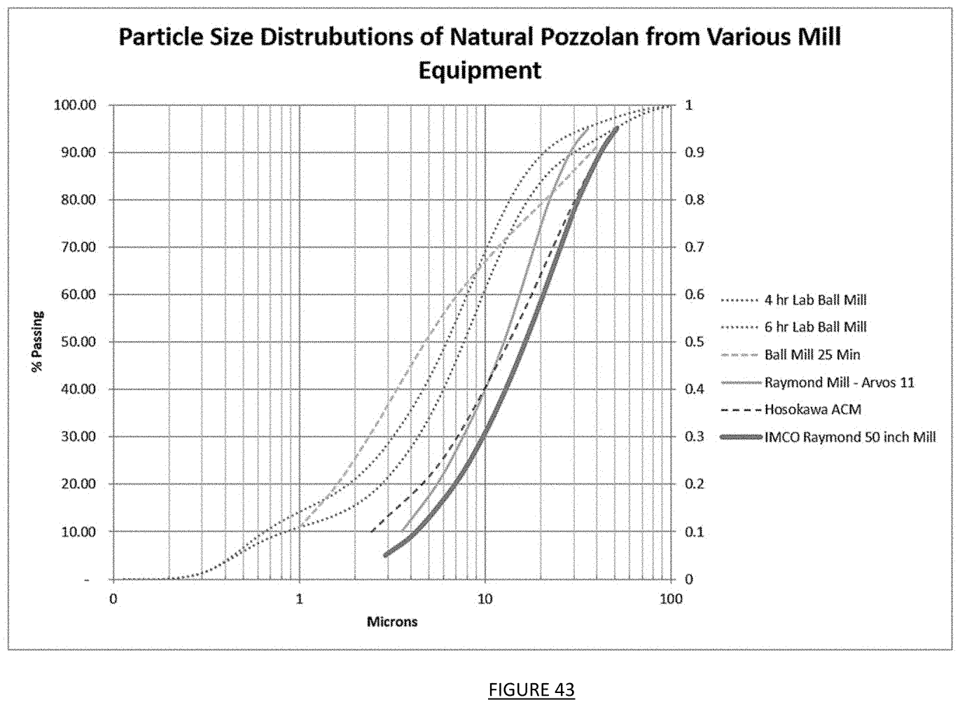

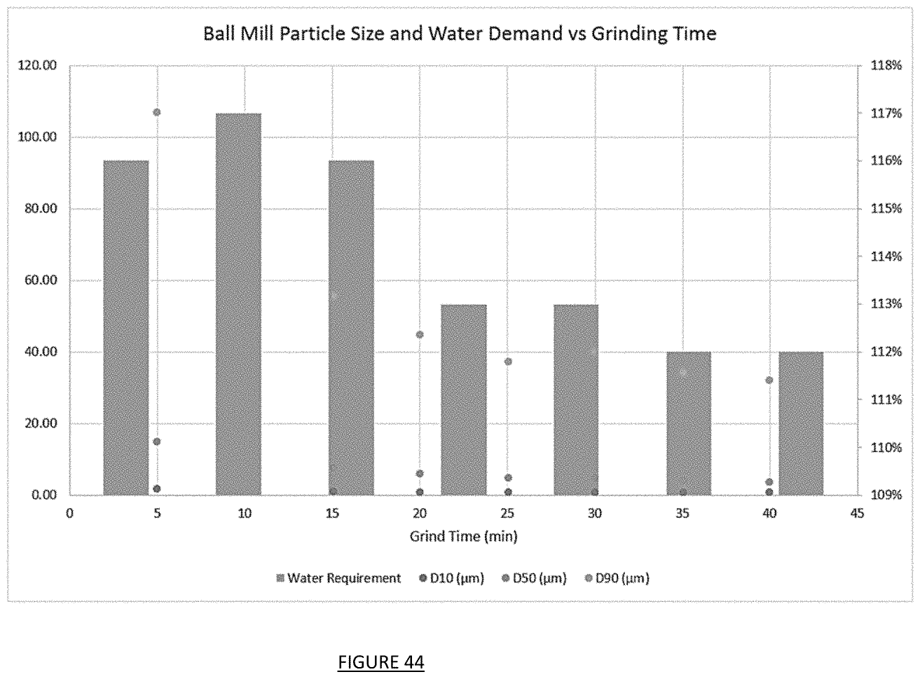

In some embodiments, the natural pozzolan is first dried and then milled to produce particle size distributions wherein the median particle size (D50, where 50% of the particles are less than the specified size) is less than 20 μm and the D90 (where 90% of the particles are less than the specified size) is less than 45 μm. For example, FIG. 43 shows particle size distribution curves for milled natural pozzolan having D50 of 5 to 20 microns and D90 of 20 to 45 microns, each of which have been used successfully in cement compositions described elsewhere herein. Other particle size distributions with larger or smaller particle sizes may also be used successfully, which may also affect water demand as described herein—see FIG. 44, for example.

Comminution equipment of various types can grind natural pozzolans, limestone, or a mixture of natural pozzolans and limestone to fine enough powders for use in cement compositions described herein. FIG. 43 also indicates several mill types that have produced particle size distributions of natural pozzolans with D50 less than 20 μm and D90 less than 45 μm, that have been used successfully in cement compositions described elsewhere herein. Other mill types may also be used successfully.

In some embodiments, milling was accomplished using a Raymond Mill, including a 50 inch Raymond Mill with mill speed of about 400 rpm, a whizzer speed of 100 to 400 rpm, a fan speed of 45-55 Hz, and a feed rate of 1-3 tons per hour with natural pozzolan feed moisture content of about 30%. In this example the feed was also dried by direct heating with up to 2 MM BTU/Hr directly into the mill.

In some embodiments, milling was accomplished using a Raymond Mill, including a 30 inch Raymond Mill with mill speed of about 450 rpm, an air classifier speed of about 800 to 9000 rpm, a fan speed of 3900 cfm, and a feed rate of 1 to 2.5 tons per hour with natural pozzolan feed moisture content of about 8 to 30%. In some of these examples the feed was also dried by direct heating of inlet air to about 60 to 650 degrees F. Based on manufacturer's data, larger sizes of the Raymond mill will presumably also produce similar product, including the 50″, 66″ and 73″ Raymond mill.

In some embodiments, milling was accomplished using an air classifying mill, including a 15 Hp Hosokawa Air Classifying Mill with rotor speed of about 5,000 to 7,000 rpm, a classifier speed of about 2,000 rpm, an airflow of about 550 to 800 SCFM, and a feed rate of 0.2 to 1.1 tons per hour with feed moisture content of about 2 to 10% of raw natural pozzolan. Based on manufacturer's data, larger sizes of the air classifying mill will presumably also produce similar product, including the 300 Hp air classifying mill.

In some embodiments milling was accomplished by inter-grinding natural pozzolan and limestone using an air classifying mill, including a 15 Hp Hosokawa air classifying mill with rotor speed of about 5,000 to 7,000 rpm, a classifier speed of 2,000 rpm, a fan speed of 2,000 to 3,000 rpm, and a feed rate of about 0.4 to 0.75 tons per hour with feed moisture content of about 2 to 10% of raw natural pozzolan about 0.4 to 0.75 tons per hour of limestone at 0 to 41% moisture and feed sizes of ⅜ inch minus to 90% passing 100 mesh. Based on manufacturer's data, larger sizes of the air classifying mill will presumably also produce similar product, including the 300 Hp air classifying mill.

In some embodiments milling was accomplished using a ball mill, including a lab scale ball mill of about 12 inches in diameter, mill speed of about 40 to 60 rpm for 2, 4, 6 or 8 hours of milling with feed of ¾″ minus natural pozzolan with a moisture content of about 0%, 2%, 4%, 6% or 8%, including any intervening moisture contents.

In some embodiments milling was accomplished using a ball mill, including a lab scale ball mill of about 12 inches in diameter, mill speed of about 40 to 60 rpm for 2, 4, 6 or 8 hours of milling with feed of 50% ¾″ minus natural pozzolan with a moisture content of about 0%, 2%, 4%, 6% or 8%, including any intervening moisture contents and 50% limestone powder with D90 passing a 100 mesh sieve and at less than 5% moisture content.

In some embodiments milling was accomplished using a Ball Mill, including a pilot scale mill of about 30 inches in diameter for 3, 6, 9, or 12 minutes of milling Lassenite with feed moisture content of about 25 to 40% or inter-grinding for 15, 20, 25, 30, 35, 40, or 45 minutes of a 50% Lassenite at 30% moisture content and 50% limestone at less than 5% moisture content, both at ¾″ minus feed sizes. FIG. 44 depicts data demonstrating successful inter-grinding in the ball mill to produce desirable particle size and water demand characteristics.

In some embodiments milling of natural pozzolan or inter-grinding natural pozzolan and limestone was accomplished using a vertical roller mill, including a 30-inch Williams vertical roller mill with direct drying the natural pozzolan feed moisture content of about 30%. Feed sizes ranged from 1-inch minus for the natural pozzolan to 1.2-inch minus for the limestone.

It should be understood that other types of mills may also be used to produce natural pozzolan powders and natural pozzolan/limestone inter-grind powders of varying utility, including some that may be effective as SCM blends in producing cement compositions and concrete that are superior to cement powders and concrete made without them.

### Example 1

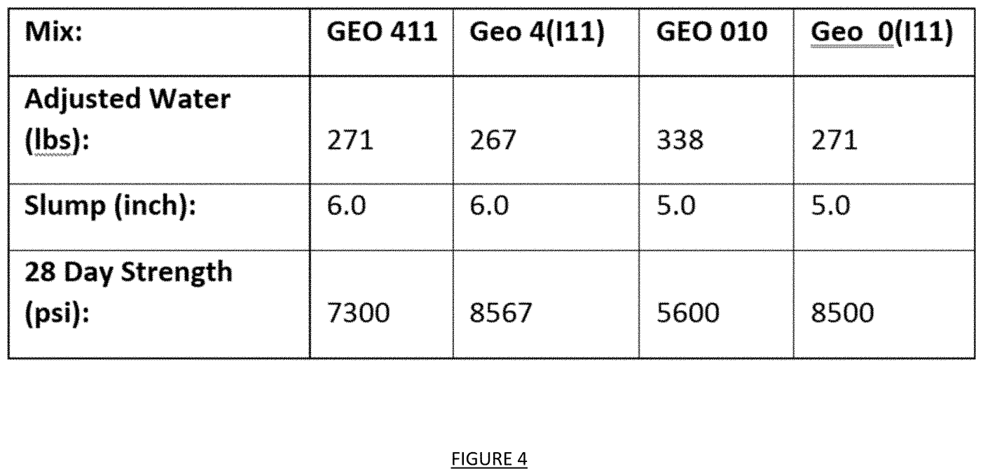

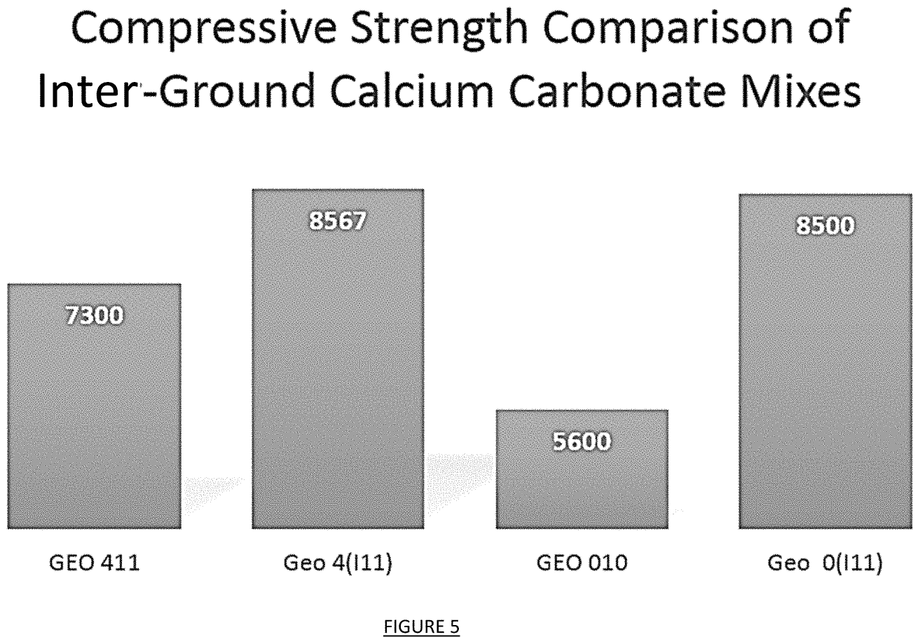

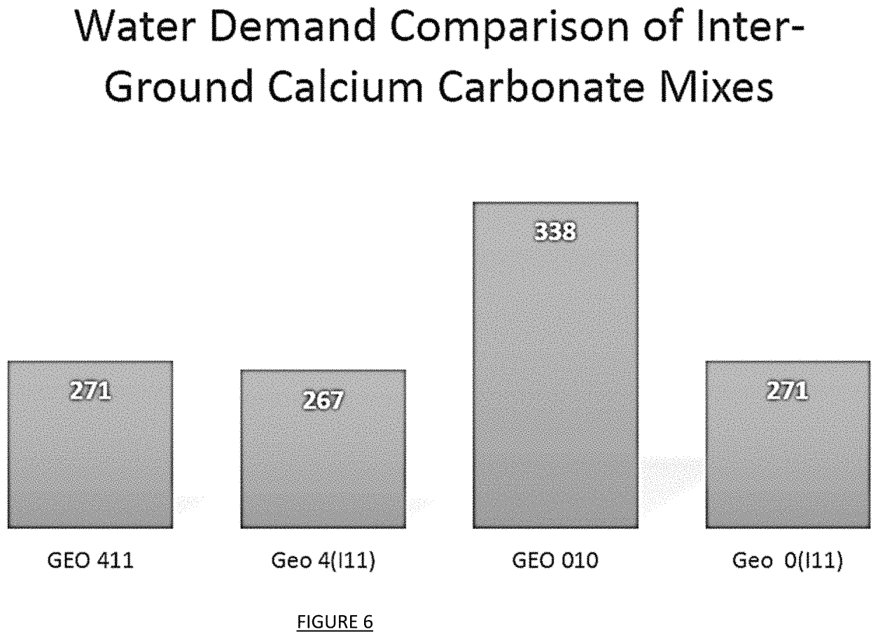

In one exemplary test, Applicant created various concrete mixes to compare the impact of inter-grinding of cement constituents versus simple blending of the same constituents. FIGS. 4, 5 and 6 depict charts of the resulting concrete mixtures and related performance measures.

MIXTURE 1—Geo411—A blend of 4 parts fly ash, 1 part natural pozzolan and 1 part calcium carbonate

MIXTURE 2—Geo4(I11)—A blend of 4 parts fly ash and 1 part natural pozzolan inter-ground with 1 part calcium carbonate

MIXTURE 3—GEO 010—Natural Pozzolan by itself

MIXTURE 4—GEO 0(I11) An inter-grind of 1 part natural pozzolan and 1 part calcium carbonate

### Example 2

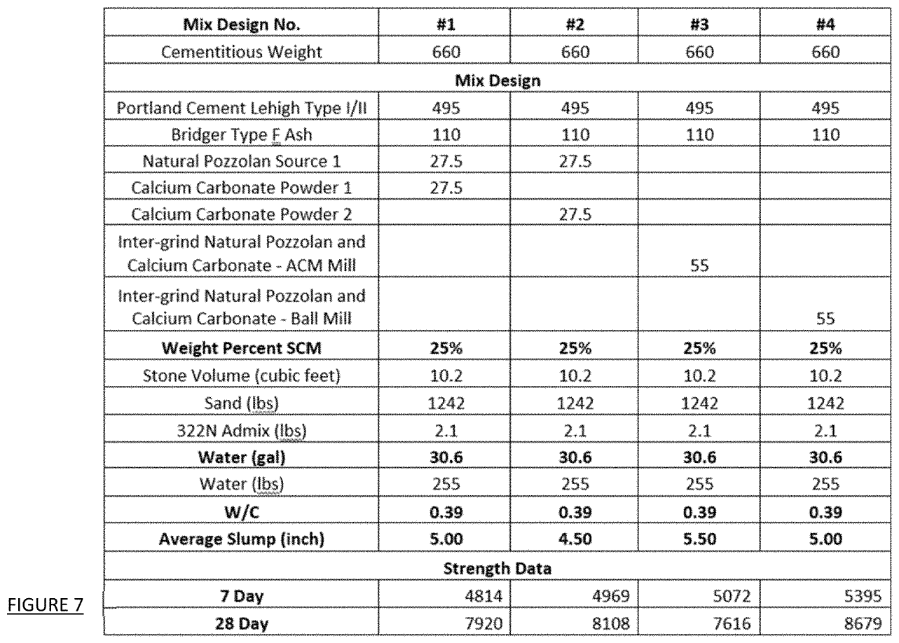

FIG. 7 depicts four exemplary concrete mixes that were created to demonstrate how well calcium carbonate can work as a blend as compared to an inter-grind constituent. The powdered calcium carbonate and natural pozzolan examples worked best with a median particle size (D50) of 25 microns or less, when blended. If the disclosed inter-grinding process is used, however, additional water reduction occurred when the median particle size after inter-grinding (D50) was less than 10 microns. The examples disclose blending or inter-grinding of calcium carbonate with natural pozzolan. In this example, inter-grinding of the constituents was compared using product from an attrition type mill like a ball mill and an air classifying mill.

### Example 3

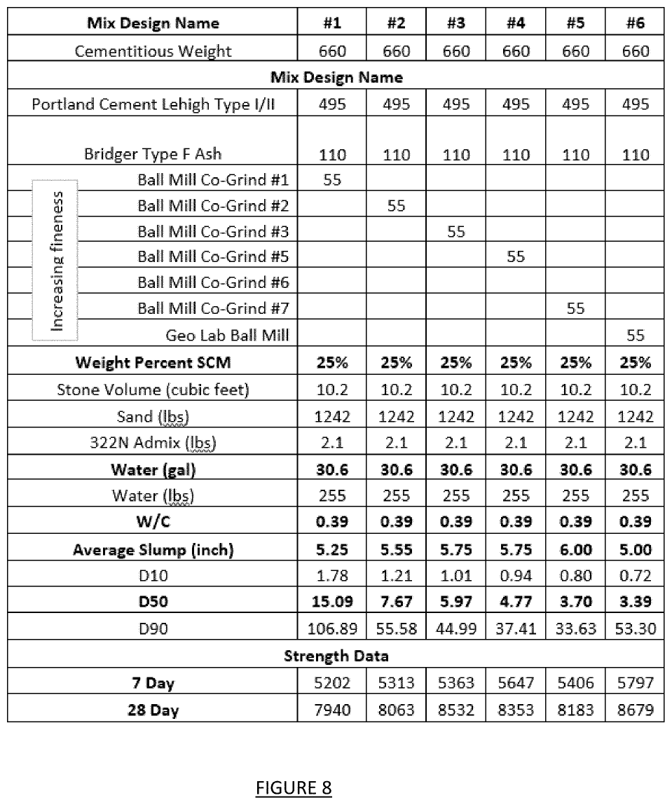

FIG. 8 depicts five exemplary concrete mixes that were created with a fixed amount of water in a ball mill. Each subsequent test had an increasingly finer inter-grind of natural pozzolan and calcium carbonate, as indicated by the D50 particle size information provided. As the fineness of the inter-grind increased, the slump increased, which is indicative of reduced water demand in the concrete mix. Accordingly, increasing the fineness of an inter-grind of natural pozzolan and calcium carbonate should increase workability of the cement mix or decrease water demand for a cement mix at the same workability.

### Example 4

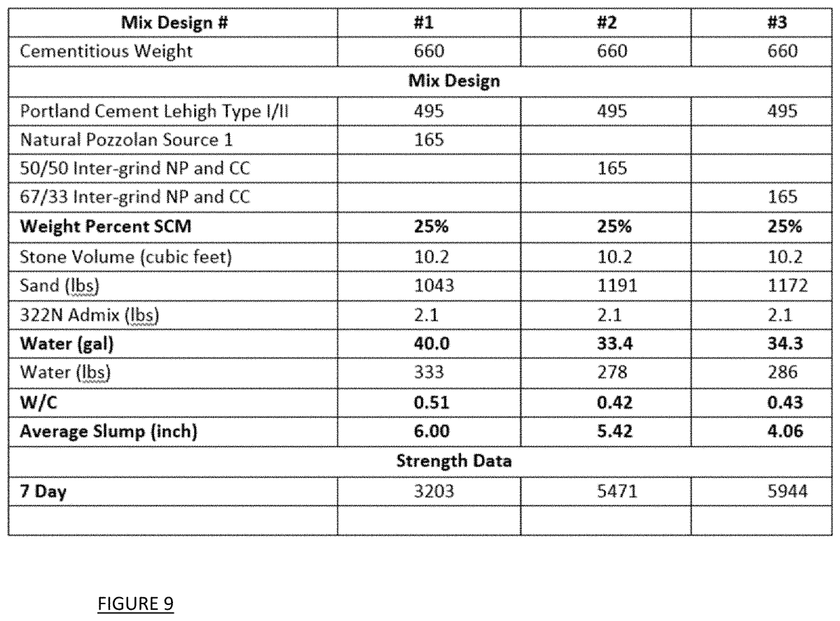

FIG. 9 depicts concrete mixes comprising constituents formed using two different formulations of inter-grinding of calcium carbonate and natural pozzolan, each of which are compared to a concrete mix comprising natural pozzolan without calcium carbonate. The cement replacement in all three cases was 25% of the Portland cement, but the water required to make a workable concrete mix in two cases was greatly reduced by the addition of the calcium carbonate as an inter-grind with the natural pozzolan. In addition, 7-day compressive strengths of the concrete mixes containing inter-ground calcium carbonate were greatly improved as compared to natural pozzolan alone, mainly due to the reduced water in the inter-ground mixes. Accordingly, it is apparent that the various disclosed methods and proportions of inter-ground calcium carbonate with natural pozzolans will significantly reduce water demand in concrete mixes as compared to a natural pozzolan by itself.

### Example 5

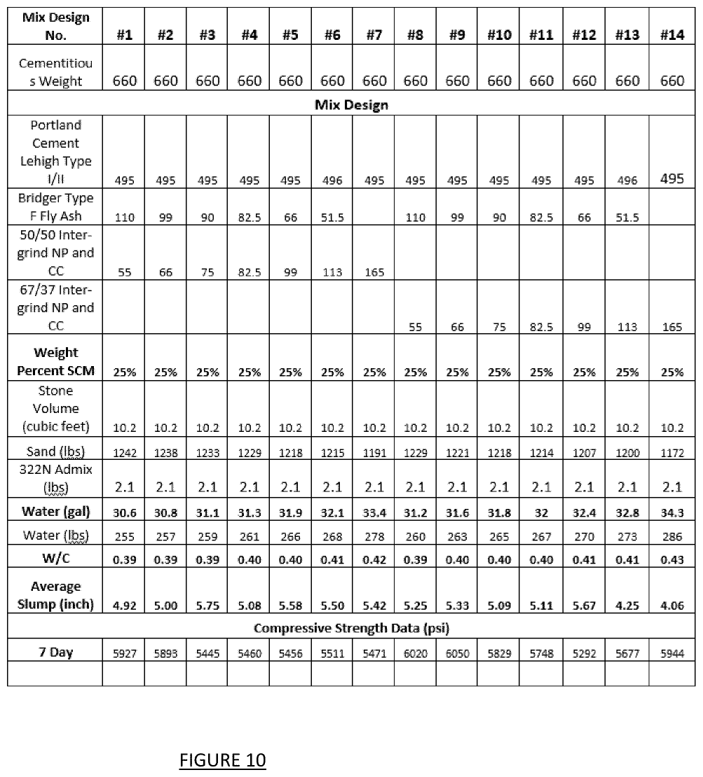

FIG. 10 depicts fourteen concrete mixes comprising various constituents and additives that were created and tested to demonstrate exemplary proportions and combinations of natural pozzolans, calcium carbonate and fly ash, all of which can be used successfully in improved concrete mixes, including replacement of some or all of the fly ash as a concrete constituent in various formulas.

### Example 6

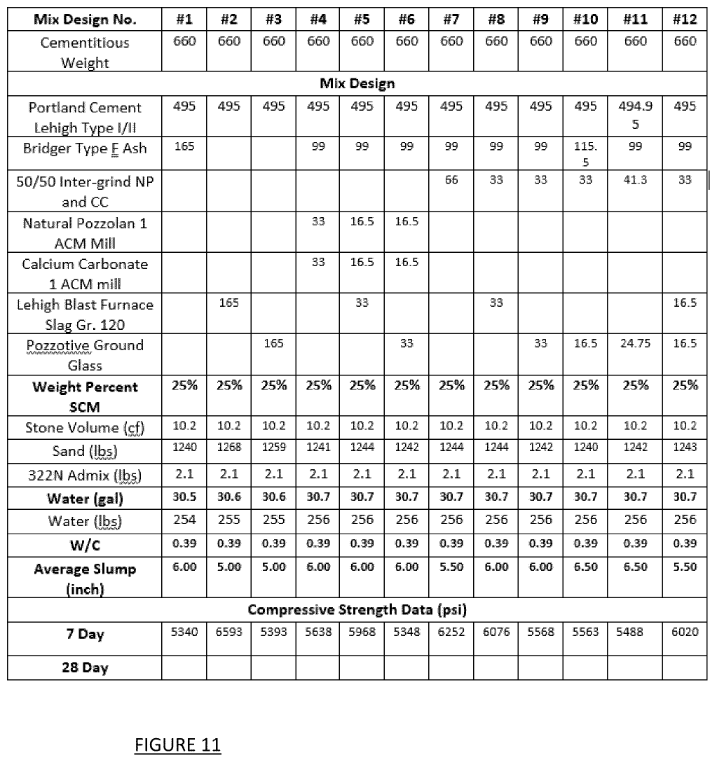

FIG. 11 depicts twelve concrete mixes comprising various constituents and additives that were created and tested to demonstrate exemplary proportions and combinations of inter-ground calcium carbonate and natural pozzolan that can be utilized with fly ash, slag cement and ground glass as concrete constituents in various formulas. Mixes 1 through 3 have been provided as standards for comparison with the remaining nine mixes, while mix 1 is a very common commercial ready mix blend. The data indicate that, generally, use of natural pozzolan and calcium carbonate produced improvements in compressive strength in all cases and that the inter-ground natural pozzolan and calcium carbonate produced greater improvements than simply blended natural pozzolan and calcium carbonate.

### Example 7

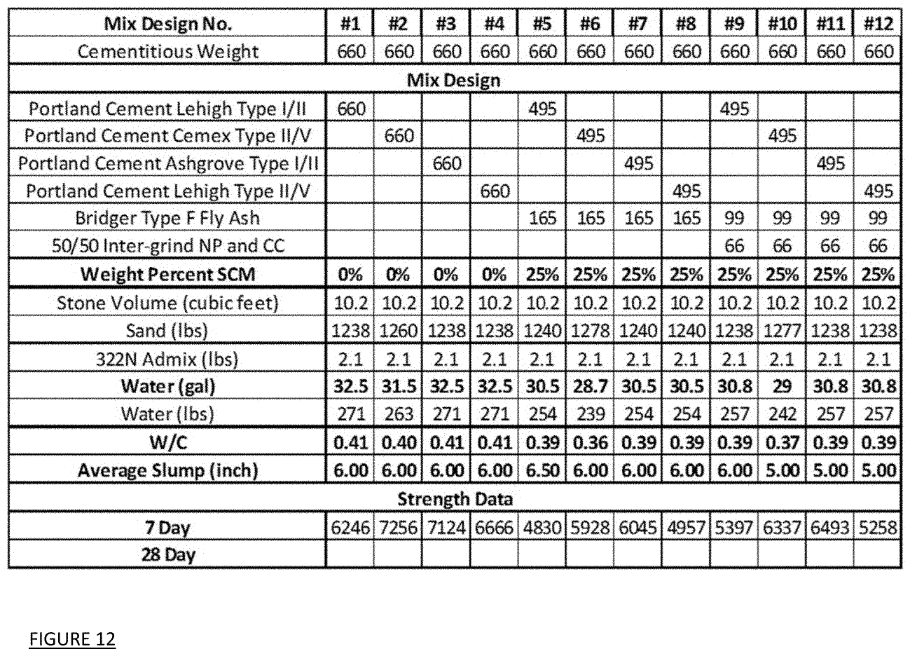

FIG. 12 depicts twelve concrete mixes comprising various constituents and additives that were created and tested to demonstrate exemplary proportions and combinations of inter-grinds of calcium carbonates and natural pozzolans that can be blended with fly ash, wherein these blended constituents can be combined with an assortment of cement types to produce useable concrete mixes. The data demonstrate that substitution of inter-grind natural pozzolan and calcium carbonate to a Portland cement/fly ash blend for some of the fly ash can improve the compressive strength of each blend for a variety of cement sources.

### Example 8

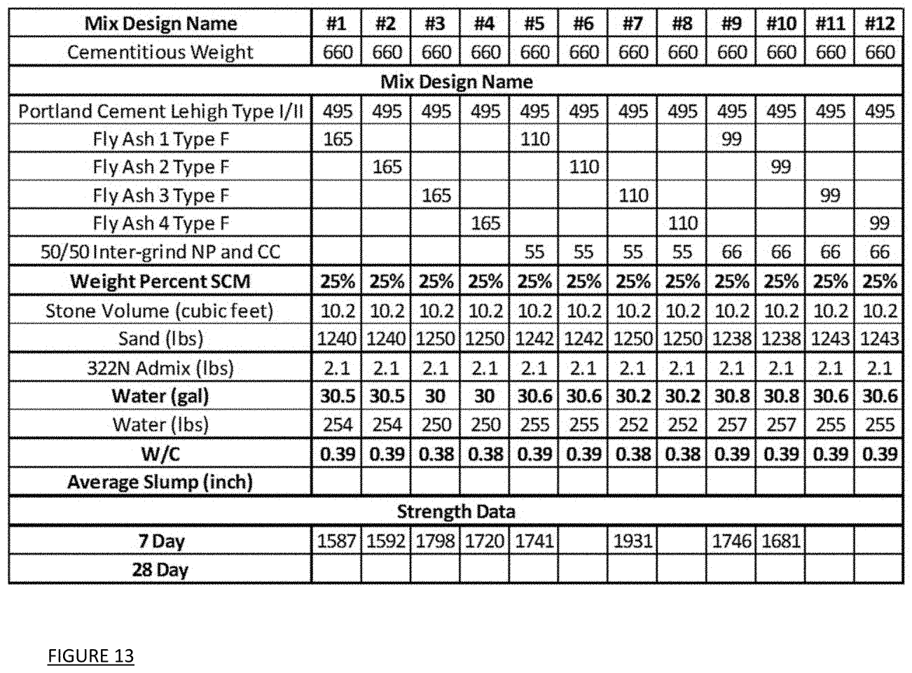

FIG. 13 depicts twelve concrete mixes comprising various constituents and additives that were created and tested to demonstrate exemplary proportions and combinations of inter-grinds of calcium carbonates and natural pozzolans that can be blended with various fly ashes. Specifically, the chart shows mixes 1 through 4 as controls for comparison, with the remaining mixes comprising inter-ground natural pozzolan and calcium carbonate blended with four different fly ash sources at two different proportions. The data demonstrate that substitution of inter-grind natural pozzolan and calcium carbonate to a Portland cement/fly ash blend for some of the fly ash can improve the compressive strength of each blend for a variety of class F fly ashes.

### Example 9

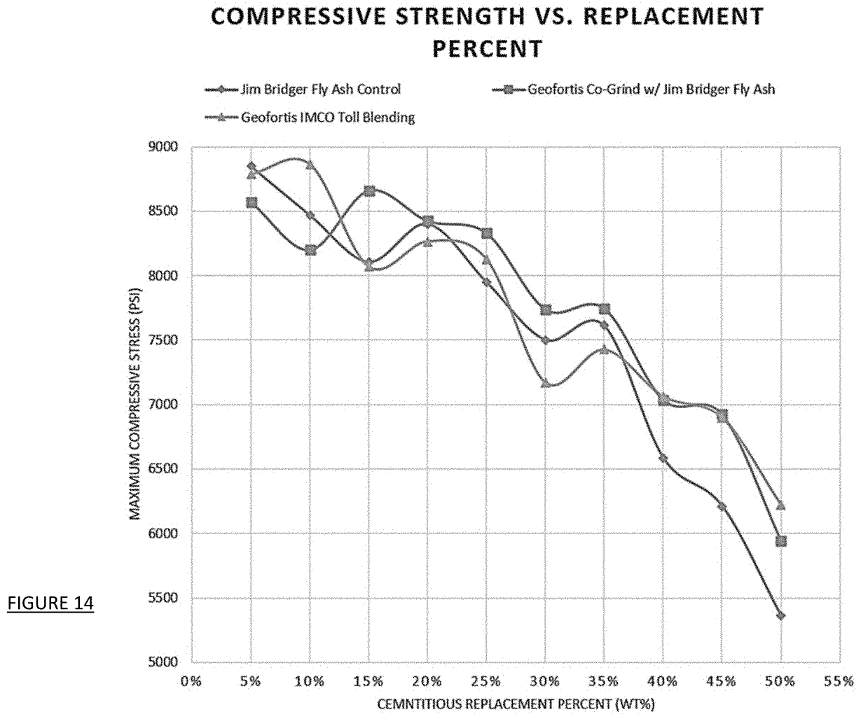

FIG. 14 depicts a chart of compressive strength versus replacement percentage for three different concrete mixes, wherein the cement is progressively replaced in concrete mixes by increasing percentages of supplemental cementitious materials. The chart demonstrates that the combination of a natural pozzolan inter-ground with calcium carbonate blended with fly ash (Geofortis Co-Grind) generally outperforms an overall blended product (Geofortis IMCO) or the fly ash by itself (Jim Bridger). The chart also demonstrates that either of the Geofortis SCM blends can perform better than fly ash alone at higher replacement percentages, demonstrating greater cement efficiency such that greater economics of Portland cement replacement are possible with natural pozzolans as compared to fly ash alone.

### Supplemental Cementitious Material (SCM) Blends

In various alternative embodiments, a wide variety of concrete and cement formulations have been developed for use in various applications, many of which were developed through a process of modeling concrete testing in mortars. In some cases, regular concrete mix designs were developed with varying blends and the resultant small mix designs were developed by making each pound a gram. In the final mini mix, stone was removed from some designs. Small batches of mortar were made in the lab, and immediate results were obtained on water demand and the consistency of the formulation. Mortar cubes were made to evaluate compressive strength at age. This testing methodology allowed rapid testing of many formulations. Additional testing of other properties such as alkali silica reactivity mitigation were also subsequently performed. Based on performance results, various advantageous and/or economical combinations for each blending location were explored.

In various embodiments, SCM formulations could comprise a natural pozzolan and one or more of the following ingredients:

Fly ash—0% to 75% (Class C, Class F, and other unspecified fly ashes)

Limestone dust—0% to 20%

Slag Cement—0% to 75%

Ground recycled glass (less than 25 microns)—0% to 40%

Silica fume—0% to 10%

Dry Admixture Citric acid—at an addition rate of (0.5 lb to 1.5 lbs)/ton of blended pozzolan

In various embodiments, initial testing of various mixes was performed by blending or inter-grinding a natural pozzolan with fly ash in a binary formulation. These formulations worked well with certain cements. Formulations with improved concrete performance ranged from 1 to 5 parts fly ash with 1 to 5 parts natural pozzolan increasing in 0.1 parts. Both class C and Class F ash worked in these formulations.

Citric Acid: In various embodiments, low dose rates (<1% per 100 wt cementitious) may act as water reducers without significant initial set retardation; and in some cases may act as a very mild accelerator. Applicants discovered that blending very small amounts of citric acid in the dry form with a natural pozzolan potentially reduces water demand in concrete mixtures with the natural pozzolans, without significantly increasing concrete setting times. The minor citric acid addition improved the final concrete mixtures. The dosage rate added to the natural pozzolans was less than or equal to 0.05% weight % of the total cementitious powder used in the concrete mixture. In some testing, rather than extending the concrete setting time the addition, of the citric acid decreased this time. Higher dosage rates of citric acid (greater than 0.05% wt replacement of total cementitious powder) in the concrete mix design can be used if the main concern is later compressive strengths or if extended concrete setting time is preferable for a specific application.

Tartaric Acid: In various embodiments, low dose rates (<0.5% per 100 wt cementitious) may act as a water reducer without significant initial set retardation. Applicants discovered that blending very small amounts of Tartaric acid in the dry form with a natural pozzolan could potentially reduce water demand in concrete mixtures with the natural pozzolans without significantly increasing concrete setting times. The minor Tartaric acid addition improved the final concrete mixtures. The dosage rate added to the natural pozzolans was less than or equal to 0.5% weight % of the total cementitious powder used in the concrete mixture. Higher dosage rates of Tartaric acid (greater than 0.5% wt replacement of total cementitious powder) in the concrete mix design can be used if the main concern is later compressive strengths or if extended concrete setting time is preferable for a specific application.

Polishing Fly Ash: In various embodiments, milling the fly ash to a point where the spherical glass particles were not broken, but rather completely separated and had their surfaces thoroughly scratched, increased workability and flow characteristics of the mix, and the packing nature of the fly ash resulting in a strength gain. The applicants discovered that fly ash could be improved by limited grinding in certain type mills. They further discovered that the significant improvements did not come from de-agglomeration of fly ash particles, but apparently from roughing of the fly ash particle surface without destruction of the spherical glass particle inherent to fly ash particles. This roughening of the fly ash particle may lead to increased reactivity of the fly ash without significantly increasing water demand in various embodiments.

Unusable Fly Ashes: In various embodiments, blends incorporating unusable ashes can be created to create a beneficial SCM product. For example, certain fly ashes, although conforming to ASTM specification C618, may not be usable in concrete due to certain chemical or physical attributes. An example is a Type F ash which has an LOI (Loss on Ignition, typically due to carbon content) within specifications, but the fineness or color of the carbon is such that it makes the fly ash unusable in concrete. Such fly ash may be made usable by blending a natural pozzolan, and/or calcium carbonate, and/or other SCMs with this problematic fly ash. By this diluting/blending the fly ash with other pozzolans, the “problem fly ash” can be made acceptable for use in various concrete mixtures and/or blends.

Blast Furnace Slag: In various embodiments, blast furnace slag and/or other constituents may be mixed into the product via blending or inter-grinding up to equal parts Lassenite and Calcium Carbonate by mass, which potentially increases compressive strength and/or mitigates detrimental effects of all species. Blast furnace slag cements have been found to react favorably with inter-grinds of natural pozzolans and calcium carbonate, thereby improving the physical and chemical properties of the concrete mixture. The proportions of slag cement to natural pozzolan to calcium carbonate can vary significantly based on the property(ies) that one is trying to improve in the final concrete mixture. Calcium Carbonate wt % in the final SCM combinations can vary from 5% to 50%. The natural pozzolan wt % in the final SCM combination can vary from 10% to 50%. One promising blend of slag cement, Lassenite inter-ground with calcium carbonate, had proportions of 50% slag cement and 50% inter-grind of natural pozzolan and calcium carbonate. The inter-grind of natural pozzolan and calcium carbonate was 50% of each constituent. Other SCM's such as ground glass or fly ash may also be blended with the slag and natural pozzolan inter-grind to produce superior concrete.

In various embodiments, different formulations of Natural Pozzolan-Calcium Carbonate inter-grind, and Blended slag cement could include:

1 part(s) slag cement (GGBFS), 1 part natural pozzolan (NP), and 1 part calcium carbonate (CC), and 1.1GGBFS:1NP:1CC, 1.2GGBFS:1NP:1CC, 1.3GGBFS:1NP:1CC, 1.4GGBFS:1NP:1CC, 1.5GGBFS:1NP:1CC, 1.6GGBFS:1NP:1CC, 1.7GGBFS:1NP:1CC, 1.8GGBFS:1NP:1CC, 1.9GGBFS:1NP:1CC, 2GGBFS:1NP:1CC, 2.1GGBFS:1NP:1CC, 2.2GGBFS:1NP:1CC, 2.3GGBFS:1NP:1CC, 2.4GGBFS:1NP:1CC, 2.5GGBFS:1NP:1CC, 2.6GGBFS:1NP:1CC, 2.7GGBFS:1NP:1CC, 2.8GGBFS:1NP:1CC, 2.9GGBFS:1NP:1CC, 3GGBFS:1NP:1CC, 3.1GGBFS:1NP:1CC, 3.2GGBFS:1NP:1CC, 3.3GGBFS:1NP:1CC, 3.4GGBFS:1NP:1CC, 3.5GGBFS:1NP:1CC, 3.6GGBFS:1NP:1CC, 3.7GGBFS:1NP:1CC, 3.8GGBFS:1NP:1CC, 3.9GGBFS:1NP:1CC, 4GGBFS:1NP:1CC, 4.1GGBFS:1NP:1CC, 4.2GGBFS:1NP:1CC, 4.3GGBFS:1NP:1CC, 4.4GGBFS:1NP:1CC, 5.5GGBFS:1NP:1CC, 4.6GGBFS:1NP:1CC, 4.7GGBFS:1NP:1CC, 4.8GGBFS:1NP:1CC, 4.9GGBFS:1NP:1CC, 5GGBFS:1NP:1CC.

1 part(s) slag cement (GGBFS), 1.1 part natural pozzolan (NP), and 1 part calcium carbonate (CC), and 1.1GGBFS:1.1NP:1CC, 1.2GGBFS:1.1NP:1CC, 1.3GGBFS:1.1NP:1CC, 1.4GGBFS:1.1NP:1CC, 1.5GGBFS:1.1NP:1CC, 1.6GGBFS:1.1NP:1CC, 1.7GGBFS:1.1NP:1CC, 1.8GGBFS:1.1NP:1CC, 1.9GGBFS:1.1NP:1CC, 2GGBFS:1.1NP:1CC, 2.1GGBFS:1.1NP:1CC, 2.2GGBFS:1.1NP:1CC, 2.3GGBFS:1.1NP:1CC, 2.4GGBFS:1.1NP:1CC, 2.5GGBFS:1.1NP:1CC, 2.6GGBFS:1.1NP:1CC, 2.7GGBFS:1.1NP:1CC, 2.8GGBFS:1.1NP:1CC, 2.9GGBFS:1.1NP:1CC, 3GGBFS:1.1NP:1CC, 3.1GGBFS:1.1NP:1CC, 3.2GGBFS:1.1NP:1CC, 3.3GGBFS:1.1NP:1CC, 3.4GGBFS:1.1NP:1CC, 3.5GGBFS:1.1NP:1CC, 3.6GGBFS:1.1NP:1CC, 3.7GGBFS:1.1NP:1CC, 3.8GGBFS:1.1NP:1CC, 3.9GGBFS:1.1NP:1CC, 4GGBFS:1.1NP:1CC, 4.1GGBFS:1.1NP:1CC, 4.2GGBFS:1.1NP:1CC, 4.3GGBFS:1.1NP:1CC, 4.4GGBFS:1.1NP:1CC, 5.5GGBFS:1.1NP:1CC, 4.6GGBFS:1.1NP:1CC, 4.7GGBFS:1.1NP:1CC, 4.8GGBFS:1.1NP:1CC, 4.9GGBFS:1.1NP:1CC, 5GGBFS:1.1NP:1CC.

1 part(s) slag cement (GGBFS), 1.2 part natural pozzolan (NP), and 1 part calcium carbonate (CC), and 1.1GGBFS:1.2NP:1CC, 1.2GGBFS:1.2NP:1CC, 1.3GGBFS:1.2NP:1CC, 1.4GGBFS:1.2NP:1CC, 1.5GGBFS:1.2NP:1CC, 1.6GGBFS:1.2NP:1CC, 1.7GGBFS:1.2NP:1CC, 1.8GGBFS:1.2NP:1CC, 1.9GGBFS:1.2NP:1CC, 2GGBFS:1.2NP:1CC, 2.1GGBFS:1.2NP:1CC, 2.2GGBFS:1.2NP:1CC, 2.3GGBFS:1.2NP:1CC, 2.4GGBFS:1.2NP:1CC, 2.5GGBFS:1.2NP:1CC, 2.6GGBFS:1.2NP:1CC, 2.7GGBFS:1.2NP:1CC, 2.8GGBFS:1.2NP:1CC, 2.9GGBFS:1.2NP:1CC, 3GGBFS:1.2NP:1CC, 3.1GGBFS:1.2NP:1CC, 3.2GGBFS:1NP:1CC, 3.3GGBFS:1.2NP:1CC, 3.4GGBFS:1.2NP:1CC, 3.5GGBFS:1.2NP:1CC, 3.6GGBFS:1.2NP:1CC, 3.7GGBFS:1.2NP:1CC, 3.8GGBFS:1.2NP:1CC, 3.9GGBFS:1.2NP:1CC, 4GGBFS:1NP:1CC, 4.1GGBFS:1.2NP:1CC, 4.2GGBFS:1NP:1CC, 4.3GGBFS:1.2NP:1CC, 4.4GGBFS:1NP:1CC, 4.5GGBFS:1.2NP:1CC, 4.6GGBFS:1.2NP:1CC, 4.7GGBFS:1NP:1CC, 4.8GGBFS:1.2NP:1CC, 4.9GGBFS:1NP:1CC, 5GGBFS:1.2NP:1CC.

1 part(s) slag cement (GGBFS), 1.3 part natural pozzolan (NP), and 1 part calcium carbonate (CC), and 1.1GGBFS:1.3NP:1CC, 1.2GGBFS:1.3NP:1CC, 1.3GGBFS:1.3NP:1CC, 1.4GGBFS:1.3NP:1CC, 1.5GGBFS:1.3NP:1CC, 1.6GGBFS:1.3NP:1CC, 1.7GGBFS:1.3NP:1CC, 1.8GGBFS:1.3NP:1CC, 1.9GGBFS:1.3NP:1CC, 2GGBFS:1.3NP:1CC, 2.1GGBFS:1.3NP:1CC, 2.2GGBFS:1.3NP:1CC, 2.3GGBFS:1.3NP:1CC, 2.4GGBFS:1.3NP:1CC, 2.5GGBFS:1.3NP:1CC, 2.6GGBFS:1.3NP:1CC, 2.7GGBFS:1.3NP:1CC, 2.8GGBFS:1.3NP:1CC, 2.9GGBFS:1.3NP:1CC, 3GGBFS:1.3NP:1CC, 3.1GGBFS:1.3NP:1CC, 3.2GGBFS:1.3NP:1CC, 3.3GGBFS:1.3NP:1CC, 3.4GGBFS:1.3NP:1CC, 3.5GGBFS:1.3NP:1CC, 3.6GGBFS:1.3NP:1CC, 3.7GGBFS:1.3NP:1CC, 3.8GGBFS:1.3NP:1CC, 3.9GGBFS:1.3NP:1CC, 4GGBFS:1.3NP:1CC, 4.1GGBFS:1.3NP:1CC, 4.2GGBFS:1.3NP:1CC, 4.3GGBFS:1.3NP:1CC, 4.4GGBFS:1.3NP:1CC, 4.5GGBFS:1.3NP:1CC, 4.6GGBFS:1.3NP:1CC, 4.7GGBFS:1.3NP:1CC, 4.8GGBFS:1.3NP:1CC, 4.9GGBFS:1.3NP:1CC, 5GGBFS:1.3NP:1CC.

1 part(s) slag cement (GGBFS), 1.4 part natural pozzolan (NP), and 1 part calcium carbonate (CC), and 1.1GGBFS:1.4NP:1CC, 1.2GGBFS:1.4NP:1CC, 1.3GGBFS:1.4NP:1CC, 1.4GGBFS:1.4NP:1CC, 1.5GGBFS:1.4NP:1CC, 1.6GGBFS:1.4NP:1CC, 1.7GGBFS:1.4NP:1CC, 1.8GGBFS:1.4NP:1CC, 1.9GGBFS:1.4NP:1CC, 2GGBFS:1.4NP:1CC, 2.1GGBFS:1.4NP:1CC, 2.2GGBFS:1.4NP:1CC, 2.3GGBFS:1.4NP:1CC, 2.4GGBFS:1.4NP:1CC, 2.5GGBFS:1.4NP:1CC, 2.6GGBFS:1.4NP:1CC, 2.7GGBFS:1.4NP:1CC, 2.8GGBFS:1.4NP:1CC, 2.9GGBFS:1.4NP:1CC, 3GGBFS:1.4NP:1CC, 3.1GGBFS:1.4NP:1CC, 3.2GGBFS: 1.4NP:1CC, 3.3GGBFS: 1.4NP:1CC, 3.4GGBFS: 1.4NP:1CC, 3.5GGBFS: 1.4NP:1CC, 3.6GGBFS: 1.4NP:1CC, 3.7GGBFS: 1.4NP:1CC, 3.8GGBFS: 1.4NP:1CC, 3.9GGBFS: 1.4NP:1CC, 4GGBFS:1.4NP:1CC, 4.1GGBFS:1.4NP:1CC, 4.2GGBFS:1.4NP:1CC, 4.3GGBFS:1.4NP:1CC, 4.4GGBFS:1.4NP:1CC, 4.5GGBFS:1.4NP:1CC, 4.6GGBFS:1.4NP:1CC, 4.7GGBFS:1.4NP:1CC, 4.8GGBFS:1.4NP:1CC, 4.9GGBFS:1.4NP:1CC, 5GGBFS:1.4NP:1CC.

1 part(s) slag cement (GGBFS), 1.5 part natural pozzolan (NP), and 1 part calcium carbonate (CC), and 1.1GGBFS:1.5NP:1CC, 1.2GGBFS:1.5NP:1CC, 1.3GGBFS:1.5NP:1CC, 1.4GGBFS:1.5NP:1CC, 1.5GGBFS:1.5NP:1CC, 1.6GGBFS:1.5NP:1CC, 1.7GGBFS:1.5NP:1CC, 1.8GGBFS:1.5NP:1CC, 1.9GGBFS:1.5NP:1CC, 2GGBFS:1.5NP:1CC, 2.1GGBFS:1.5NP:1CC, 2.2GGBFS:1.5NP:1CC, 2.3GGBFS:1.5NP:1CC, 2.4GGBFS:1.5NP:1CC, 2.5GGBFS:1.5NP:1CC, 2.6GGBFS:1.5NP:1CC, 2.7GGBFS:1.5NP:1CC, 2.8GGBFS:1.5NP:1CC, 2.9GGBFS:1.5NP:1CC, 3GGBFS:1.5NP:1CC, 3.1GGBFS:1.5NP:1CC, 3.2GGBFS: 1.5NP:1CC, 3.3GGBFS: 1.5NP:1CC, 3.4GGBFS: 1.5NP:1CC, 3.5GGBFS: 1.5NP:1CC, 3.6GGBFS: 1.5NP:1CC, 3.7GGBFS: 1.5NP:1CC, 3.8GGBFS: 1.5NP:1CC, 3.9GGBFS: 1.5NP:1CC, 4GGBFS:1.5NP:1CC, 4.1GGBFS:1.5NP:1CC, 4.2GGBFS:1.5NP:1CC, 4.3GGBFS:1.5NP:1CC, 4.4GGBFS:1.5NP:1CC, 4.5GGBFS:1.5NP:1CC, 4.6GGBFS:1.5NP:1CC, 4.7GGBFS:1.5NP:1CC, 4.8GGBFS:1.5NP:1CC, 4.9GGBFS:1.5NP:1CC, 5GGBFS:1.5NP:1CC.

1 part(s) slag cement (GGBFS), 1.6 part natural pozzolan (NP), and 1 part calcium carbonate (CC), and 1.1GGBFS:1.6NP:1CC, 1.2GGBFS:1.6NP:1CC, 1.3 GGBFS: 1.6NP:1CC, 1.4GGBFS:1.6NP:1CC, 1.5GGBFS:1.6NP:1CC, 1.6GGBFS:1.6NP:1CC, 1.7GGBFS:1.6NP:1CC, 1.8GGBFS:1.6NP:1CC, 1.9GGBFS:1.6NP:1CC, 2GGBFS:1.6NP:1CC, 2.1GGBFS:1.6NP:1CC, 2.2GGBFS:1.6NP:1CC, 2.3GGBFS:1.6NP:1CC, 2.4GGBFS:1.6NP:1CC, 2.5GGBFS:1.6NP:1CC, 2.6GGBFS:1.6NP:1CC, 2.7GGBFS:1.6NP:1CC, 2.8GGBFS:1.6NP:1CC, 2.9GGBFS:1.6NP:1CC, 3GGBFS:1.6NP:1CC, 3.1GGBFS:1.6NP:1CC, 3.2GGBFS: 1.6NP:1CC, 3.3GGBFS: 1.6NP:1CC, 3.4GGBFS: 1.6NP:1CC, 3.5GGBFS: 1.6NP:1CC, 3.6GGBFS: 1.6NP:1CC, 3.7GGBFS: 1.6NP:1CC, 3.8GGBFS: 1.6NP:1CC, 3.9GGBFS: 1.6NP:1CC, 4GGBFS:1.6NP:1CC, 4.1GGBFS:1.6NP:1CC, 4.2GGBFS:1.6NP:1CC, 4.3GGBFS:1.6NP:1CC, 4.4GGBFS:1.6NP:1CC, 4.5GGBFS:1.6NP:1CC, 4.6GGBFS:1.6NP:1CC, 4.7GGBFS:1.6NP:1CC, 4.8GGBFS:1.6NP:1CC, 4.9GGBFS:1.6NP:1CC, 5GGBFS:1.6NP:1CC.

1 part(s) slag cement (GGBFS), 1.7 part natural pozzolan (NP), and 1 part calcium carbonate (CC), and 1.1GGBFS:1.7NP:1CC, 1.2GGBFS:1.7NP:1CC, 1.3GGBFS:1.7NP:1CC, 1.4GGBFS:1.7NP:1CC, 1.5GGBFS:1.7NP:1CC, 1.6GGBFS:1.7NP:1CC, 1.7GGBFS:1.7NP:1CC, 1.8GGBFS:1.7NP:1CC, 1.9GGBFS:1.7NP:1CC, 2GGBFS:1.7NP:1CC, 2.1GGBFS:1.7NP:1CC, 2.2GGBFS:1.7NP:1CC, 2.3GGBFS:1.7NP:1CC, 2.4GGBFS:1.7NP:1CC, 2.5GGBFS:1.7NP:1CC, 2.6GGBFS:1.7NP:1CC, 2.7GGBFS:1.7NP:1CC, 2.8GGBFS:1.7NP:1CC, 2.9GGBFS:1.7NP:1CC, 3GGBFS:1.7NP:1CC, 3.1GGBFS:1.7NP:1CC, 3.2GGBFS: 1.7NP:1CC, 3.3GGBFS: 1.7NP:1CC, 3.4GGBFS: 1.7NP:1CC, 3.5GGBFS: 1.7NP:1CC, 3.6GGBFS: 1.7NP:1CC, 3.7GGBFS: 1.7NP:1CC, 3.8GGBFS: 1.7NP:1CC, 3.9GGBFS: 1.7NP:1CC, 4GGBFS:1.7NP:1CC, 4.1GGBFS:1.7NP:1CC, 4.2GGBFS:1.7NP:1CC, 4.3GGBFS:1.7NP:1CC, 4.4GGBFS:1.7NP:1CC, 4.5GGBFS:1.7NP:1CC, 4.6GGBFS:1.7NP:1CC, 4.7GGBFS:1.7NP:1CC, 4.8GGBFS:1.7NP:1CC, 4.9GGBFS:1.7NP:1CC, 5GGBFS:1.7NP:1CC.

1 part(s) slag cement (GGBFS), 1.8 part natural pozzolan (NP), and 1 part calcium carbonate (CC), and 1.1GGBFS:1.8NP:1CC, 1.2GGBFS:1.8NP:1CC, 1.3GGBFS:1.8NP:1CC, 1.4GGBFS:1.8NP:1CC, 1.5GGBFS:1.8NP:1CC, 1.6GGBFS:1.8NP:1CC, 1.7GGBFS:1.8NP:1CC, 1.8GGBFS:1.8NP:1CC, 1.9GGBFS:1.8NP:1CC, 2GGBFS:1.8NP:1CC, 2.1GGBFS:1.8NP:1CC, 2.2GGBFS:1.8NP:1CC, 2.3GGBFS:1.8NP:1CC, 2.4GGBFS:1.8NP:1CC, 2.5GGBFS:1.8NP:1CC, 2.6GGBFS:1.8NP:1CC, 2.7GGBFS:1.8NP:1CC, 2.8GGBFS:1.8NP:1CC, 2.9GGBFS:1.8NP:1CC, 3GGBFS:1.8NP:1CC, 3.1GGBFS:1.8NP:1CC, 3.2GGBFS: 1.8NP:1CC, 3.3GGBFS: 1.8NP:1CC, 3.4GGBFS: 1.8NP:1CC, 3.5GGBFS: 1.8NP:1CC, 3.6GGBFS: 1.8NP:1CC, 3.7GGBFS: 1.8NP:1CC, 3.8GGBFS: 1.8NP:1CC, 3.9GGBFS: 1.8NP:1CC, 4GGBFS:1.8NP:1CC, 4.1GGBFS:1.8NP:1CC, 4.2GGBFS:1.8NP:1CC, 4.3GGBFS:1.8NP:1CC, 4.4GGBFS:1.8NP:1CC, 4.5GGBFS:1.8NP:1CC, 4.6GGBFS:1.8NP:1CC, 4.7GGBFS:1.8NP:1CC, 4.8GGBFS:1.8NP:1CC, 4.9GGBFS:1.8NP:1CC, 5GGBFS:1.8NP:1CC.

1 part(s) slag cement (GGBFS), 1.9 part natural pozzolan (NP), and 1 part calcium carbonate (CC), and 1.1GGBFS:1.9NP:1CC, 1.2GGBFS:1.9NP:1CC, 1.3GGBFS:1.9NP:1CC, 1.4GGBFS:1.9NP:1CC, 1.5GGBFS:1.9NP:1CC, 1.6GGBFS:1.9NP:1CC, 1.7GGBFS:1.9NP:1CC, 1.8GGBFS:1.9NP:1CC, 1.9GGBFS:1.9NP:1CC, 2GGBFS:1.9NP:1CC, 2.1GGBFS:1.9NP:1CC, 2.2GGBFS:1.9NP:1CC, 2.3GGBFS:1.9NP:1CC, 2.4GGBFS:1.9NP:1CC, 2.5GGBFS:1.9NP:1CC, 2.6GGBFS:1.9NP:1CC, 2.7GGBFS:1.9NP:1CC, 2.8GGBFS:1.9NP:1CC, 2.9GGBFS:1.9NP:1CC, 3GGBFS:1.9NP:1CC, 3.1GGBFS:1.9NP:1CC, 3.2GGBFS: 1.9NP:1CC, 3.3GGBFS: 1.9NP:1CC, 3.4GGBFS: 1.9NP:1CC, 3.5GGBFS: 1.9NP:1CC, 3.6GGBFS: 1.9NP:1CC, 3.7GGBFS: 1.9NP:1CC, 3.8GGBFS: 1.9NP:1CC, 3.9GGBFS: 1.9NP:1CC, 4GGBFS:1.9NP:1CC, 4.1GGBFS:1.9NP:1CC, 4.2GGBFS:1.9NP:1CC, 4.3GGBFS:1.9NP:1CC, 4.4GGBFS:1.9NP:1CC, 4.5GGBFS:1.9NP:1CC, 4.6GGBFS:1.9NP:1CC, 4.7GGBFS:1.9NP:1CC, 4.8GGBFS:1.9NP:1CC, 4.9GGBFS:1.9NP:1CC, 5GGBFS:1.9NP:1CC.

1 part(s) slag cement (GGBFS), 2 part natural pozzolan (NP), and 1 part calcium carbonate (CC), and 1.1GGBFS:2 NP:1CC, 1.2GGBFS:2 NP:1CC, 1.3GGBFS:2 NP:1CC, 1.4GGBFS:2 NP:1CC, 1.5GGBFS:2 NP:1CC, 1.6GGBFS:2 NP:1CC, 1.7GGBFS:2 NP:1CC, 1.8GGBFS:2 NP:1CC, 1.9GGBFS:2 NP:1CC, 2GGBFS:2 NP:1CC, 2.1GGBFS:2 NP:1CC, 2.2GGBFS:2 NP:1CC, 2.3GGBFS:2 NP:1CC, 2.4GGBFS:2 NP:1CC, 2.5GGBFS:2 NP:1CC, 2.6GGBFS:2 NP:1CC, 2.7GGBFS:2 NP:1CC, 2.8GGBFS:2 NP:1CC, 2.9GGBFS:2 NP:1CC, 3GGBFS:2 NP:1CC, 3.1GGBFS:2 NP:1CC, 3.2GGBFS:2 NP:1CC, 3.3GGBFS:2 NP:1CC, 3.4GGBFS:2 NP:1CC, 3.5GGBFS:2 NP:1CC, 3.6GGBFS:2 NP:1CC, 3.7GGBFS:2 NP:1CC, 3.8GGBFS:2 NP:1CC, 3.9GGBFS:2 NP:1CC, 4GGBFS:2 NP:1CC, 4.1GGBFS:2 NP:1CC, 4.2GGBFS:2 NP:1CC, 4.3GGBFS:2 NP:1CC, 4.4GGBFS:2 NP:1CC, 4.5GGBFS:2 NP:1CC, 4.6GGBFS:2 NP:1CC, 4.7GGBFS:2 NP:1CC, 4.8GGBFS:2 NP:1CC, 4.9GGBFS:2 NP:1CC, 5GGBFS:2 NP:1CC.

Ground Glass (Cutlet): In various embodiments, ground glass could be dosed no more than equal weight to Lassenite and Calcium Carbonate by mass in the product. Dosing can be done either by blending or inter-grinding the glass with the Lassenite/calcium carbonate species.

Blending/Inter-grinding with Lassenite and/or other natural pozzolans: Dosing the product with Lassenite and/or other natural pozzolans can create a superior product. For example, in various embodiments it has been found that ground glass can be inter-ground or blended with inter-grinds of natural pozzolans and calcium carbonate to improve concrete properties. Additions of slag cement to these blends can further improve concrete performance.

Hydrated Lime: In various embodiments, hydrate lime may be dosed as a final mixed item at the ready-mix plant, or by addition at the end of milling, and this addition desirably maintains or increases strength of the resulting cement(s). It has been found that hydrated lime can be blended with natural pozzolans while maintaining early strengths and improving long-term compressive strengths. Replacement rates up to 20% of the SCM formulation are possible.

Lime Kiln Dust: In various embodiments, it has been found that the addition of Thermogel (commercially available from LHOIST of Fort Worth, Tex., USA), IGS (commercially available from LHOIST of Fort Worth, Tex., USA), and/or Lime Kiln Dust to no more than 10% by weight to the SCM blended product can potentially improve concrete properties with no appreciable decrease in strength.

Class C Fly Ash: In various embodiments, class C fly ash may be used in a similar and/or identical manner to Class F Fly Ash.

Silica Fume: In various embodiments, it has been found that silica fume can be added, either by blending or inter-grinding, to the natural pozzolan or natural pozzolan/calcium carbonate combination by no more than 30% by weight of SCM blended product will desirably increase strength performance and ASR mitigation.

### Example 10

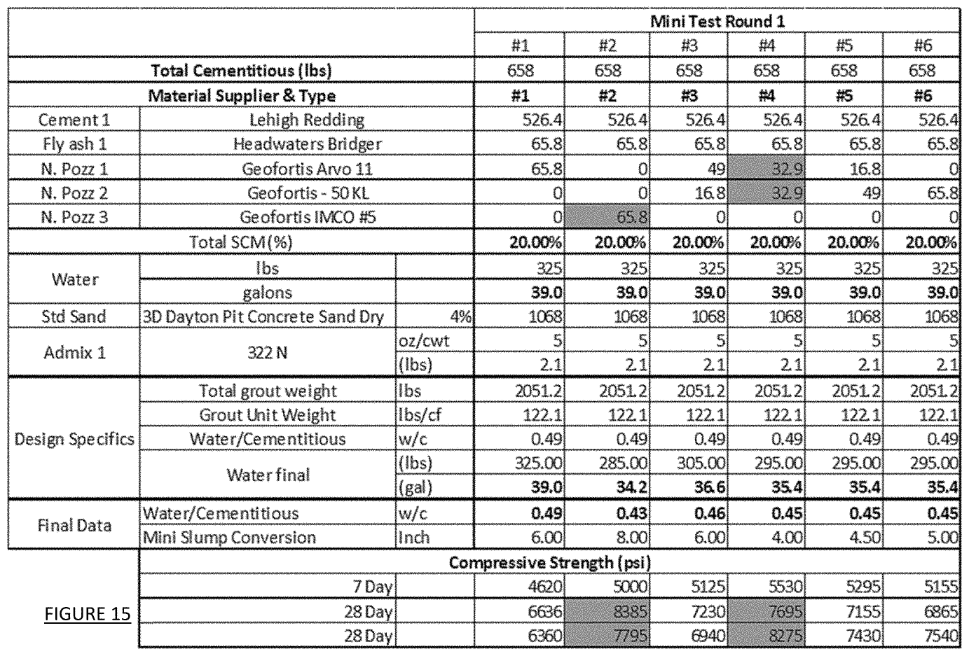

FIG. 15 depicts a chart of testing done to compare the results of natural pozzolan mixing with Class F Fly Ash. Included is the mix design itself in the upper part of the table, followed by water, aggregate totals, and admixture totals. The total design specifics and final product data are also included. At the very bottom of the table is the strength performance at various stages of age. The table shows a mixture of natural pozzolan referred to as N. Pozz 1 through 3 (each a different particle size distribution of similar material), and class f fly ash, replacing 20% by weight Portland cement. After review of water demand and compressive strengths, various of the top performing mixes were then moved onto further testing.

### Example 11

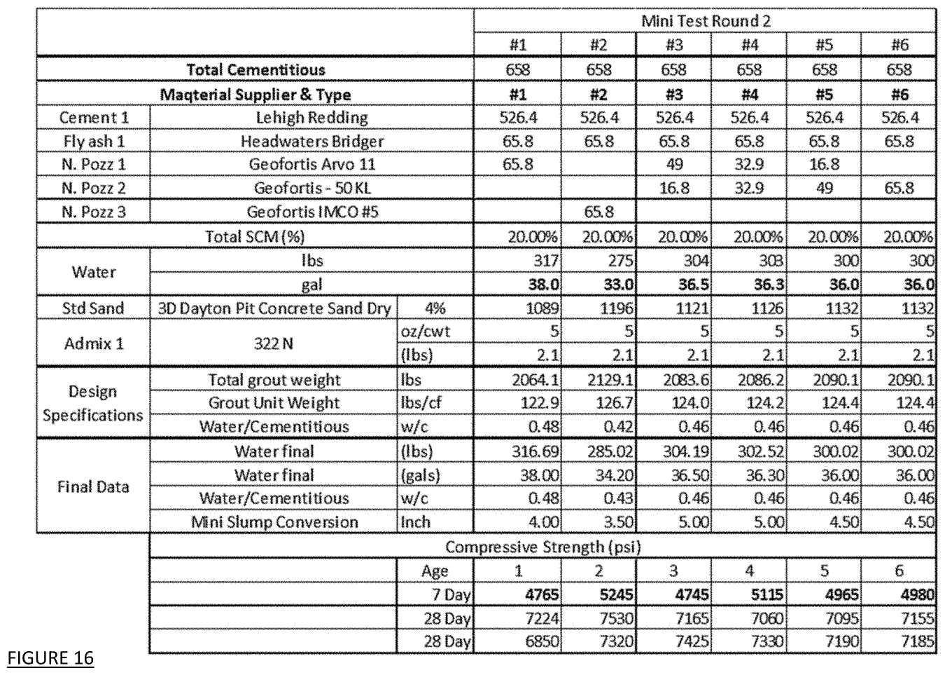

FIG. 16 depicts a chart of testing done to compare the results of natural pozzolan mixing with class f fly ash. The mix design is the upper portion of the table, followed by water, stone, and admixture values; then finally the design specification and final mix data. The very bottom has the strength test results from various ages of the mixes. Test number two is a repeated test from mini test round 1 to show the evolution of the design. The water content was reduced and as such the slump was reduced as well. This table shows the evolution of the testing done with class f fly ash. Sample number 2 is a similar mix design from FIG. 15, however, the water total has been changed. As a result, the slump has decreased and the strength performance has changed.

### Example 12

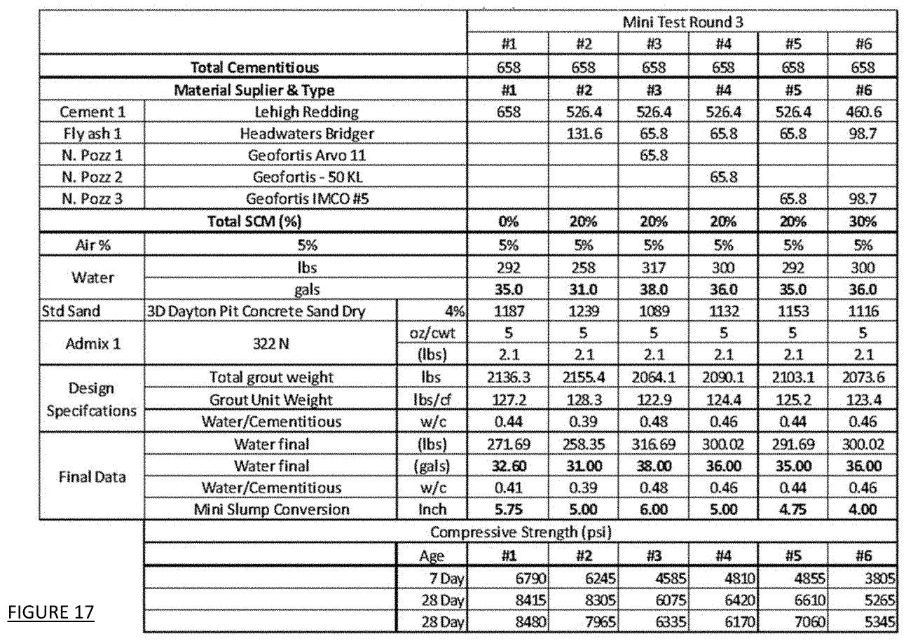

FIG. 17 depicts a chart of tests done comparing natural pozzolan mixing with class f fly ash. Mix design is the upper portion of the table showing an increase in the mass used of pozzolan and fly ash on test number 6. This information is followed by water, stone, and admixture values. Test numbers 5 and 6 are approximations and/or escalations of test number 2 in FIGS. 15 and 16. Of particular interest on this table is test number 6, where the total replaced value of Portland cement has been increased up to 30%. Strength values are given at the very bottom of the table, and show that there is a moderate drop off in strength at the higher replacement values. The class f fly ash is at 15% by weight, and the natural pozzolan is at 15% by weight of the total mix. This ratio is a one to one ratio, as testing continued the ratio was adjusted to find an optimum that balanced water demand, w/c ratio, and strength.

Additional testing was performed by blending calcium carbonate dust with the fly ash natural pozzolan blends provided above. The formulations varied from 1 to 5 parts fly ash with 1 to 5 parts natural pozzolan with 1 to 5 parts.

### Example 13

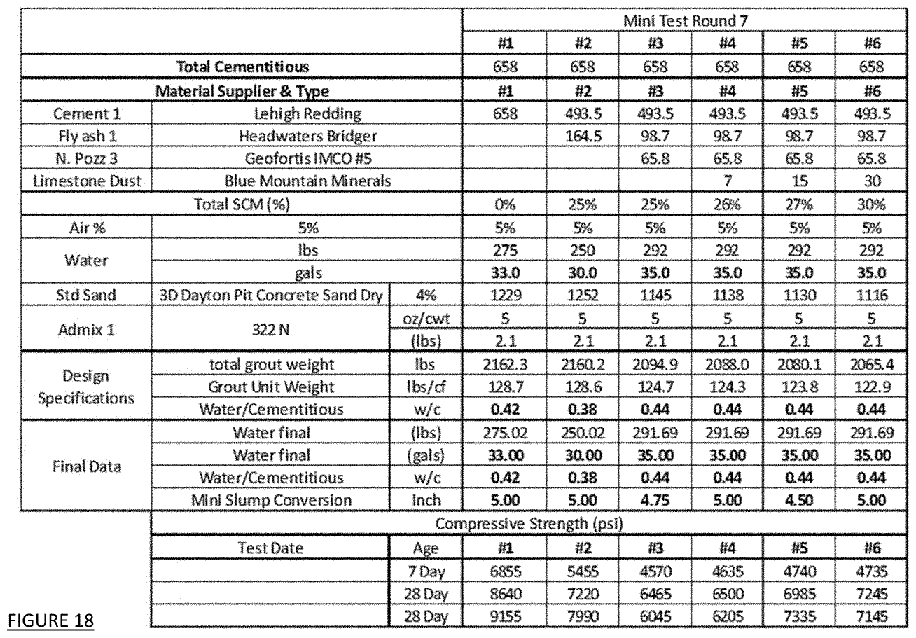

FIG. 18 depicts a chart of tests including limestone dust added with the natural pozzolan material and fly ash. This mix design shows a potential for some water reduction with the inclusion of limestone dust, as can be seen in tests number 5 and 6. Further testing and evaluation of limestone dust as a material were conducted, which showed the potential for limestone dust to be an important material within the design of SCM Cement and Concrete products due to the water reducing nature, as well as an increase in density.

### Example 14

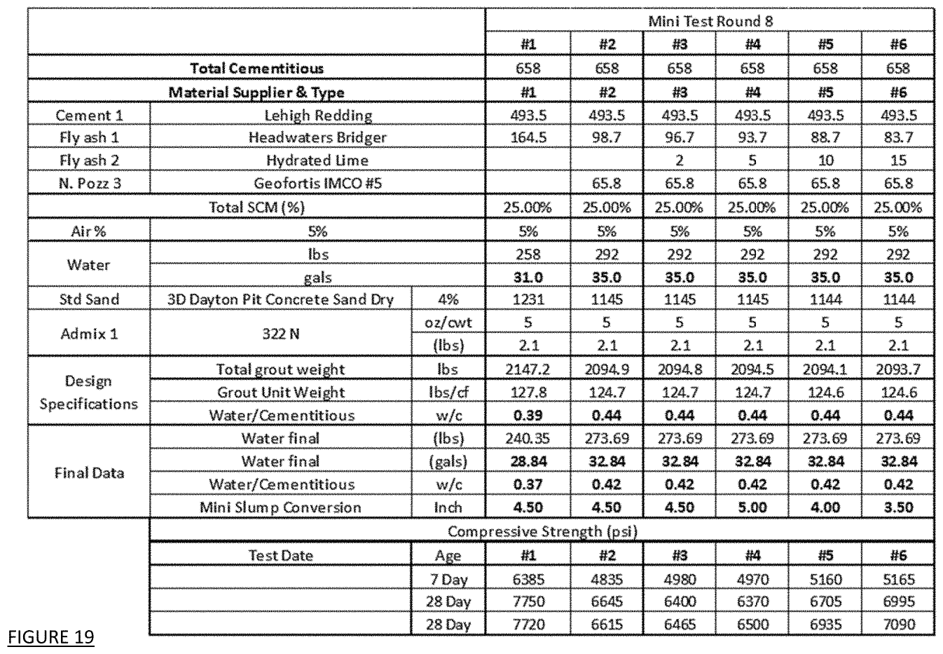

FIG. 19 depicts a chart of tests including hydrated lime.

### Example 15

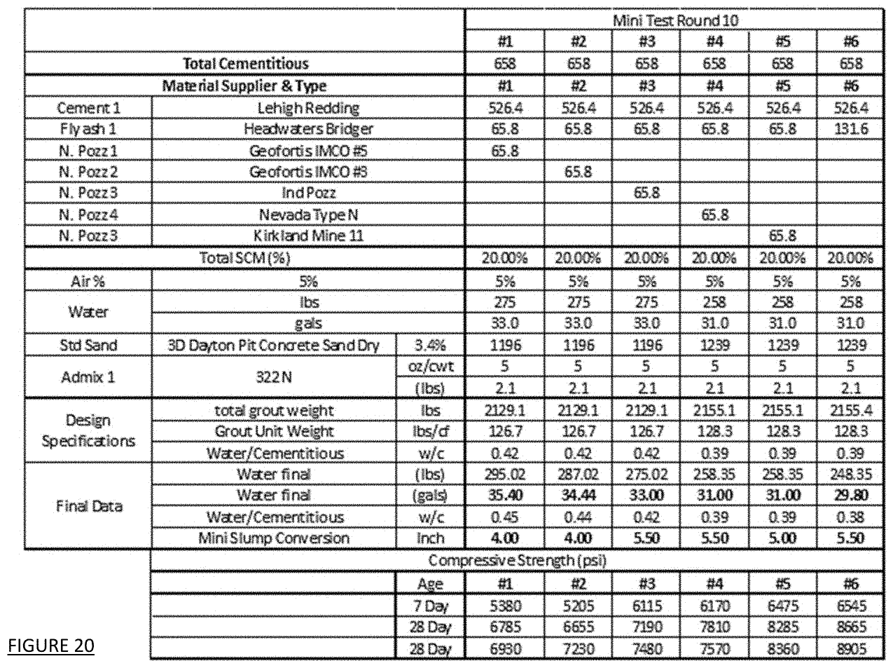

FIG. 20 depicts a chart of tests including various natural pozzolan materials against fly ash alone controls, indicating that natural pozzolans generally have increased water demand compared to fly ash and indicating a potential need for the formulations and methods developed and disclosed under this application. The several natural pozzolans represent variation in geographic and geologic sources and variations in particle size distributions.

### Example 16

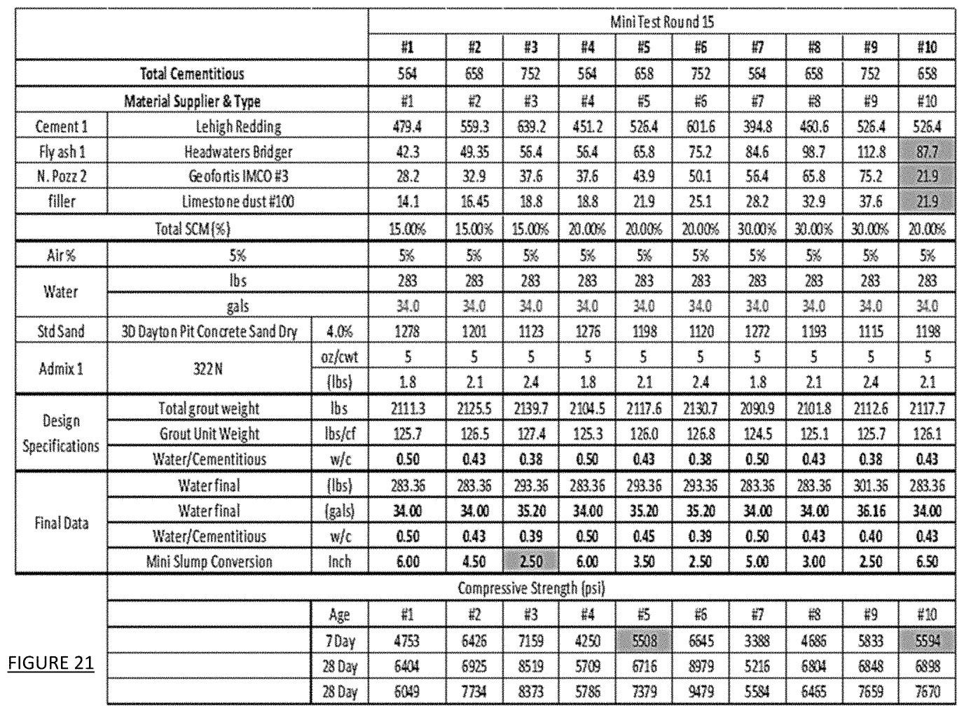

FIG. 21 depicts a chart of tests including experiments using limestone dust as a SCM. The overall ratios of SCMs range from 3 to 2 to 1 (Fly Ash, Pozzolan, Limestone Dust), to 4 to 1 to 1 (Fly Ash, Pozzolan, Limestone Dust), the latter ratio is highlighted as mix number 10 at the end of the table. Shaded seven-day strengths show an increased value over the previously established strength trend, and as such those designs were further evaluated.

### Example 17

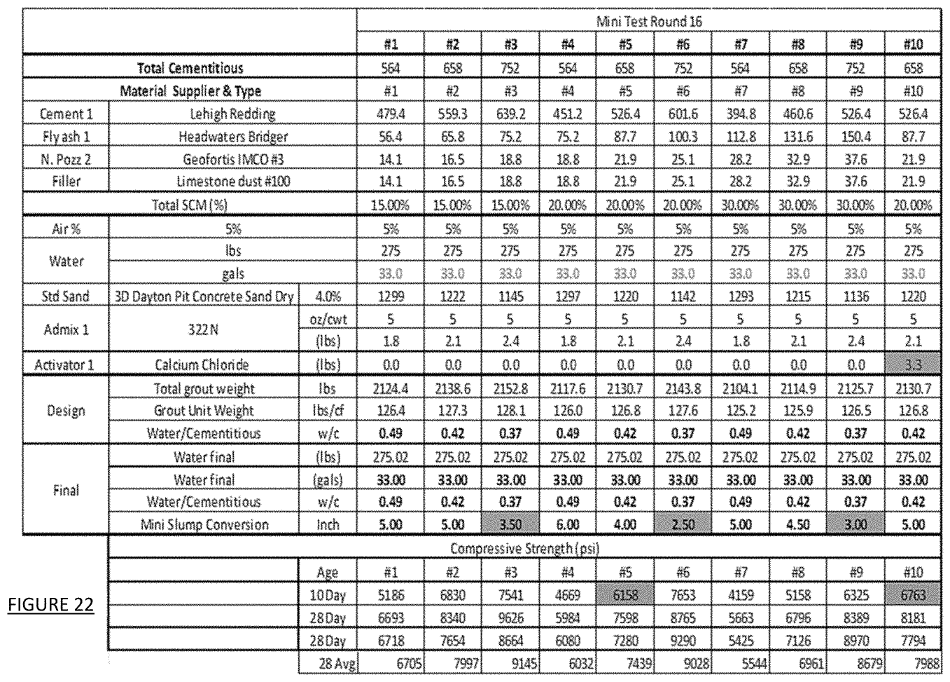

FIG. 22 depicts a chart testing the effective use of limestone dust in various SCM designs. This time the entire test is done at a ratio of 4:1:1 (Fly Ash, Pozzolan, Limestone Dust), but the total weight of cement is changed as well as the percent replacement. The addition of calcium chloride as an activator shows that there is potential to improve early performance strength of the SCM design.

### Example 18

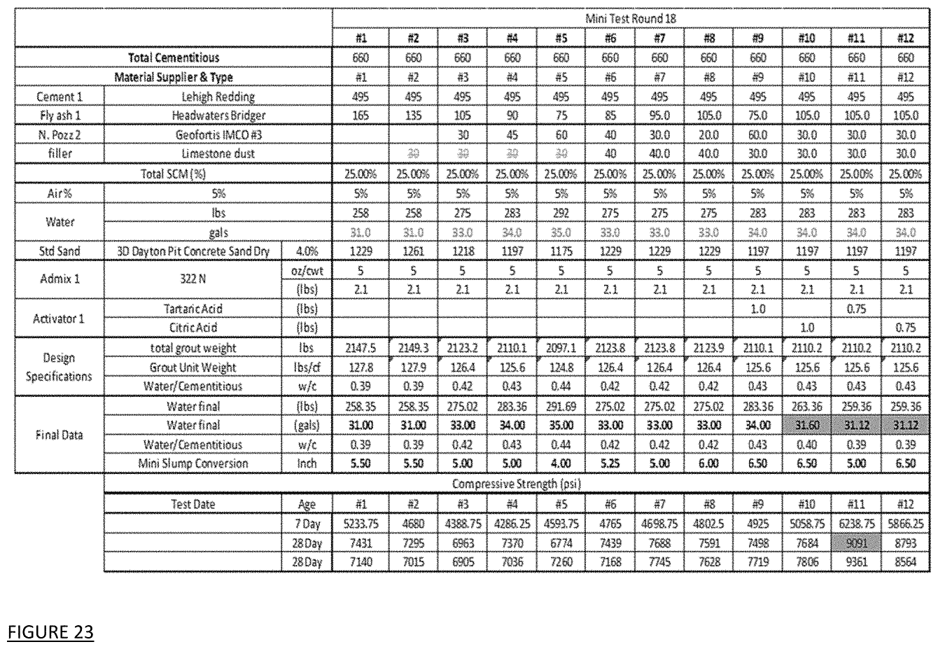

FIG. 23 depicts a chart testing limestone dust with the addition of small amounts of acid. The acid is desirably added to reduce the total water demand and to act as an accelerant. In small enough doses, compared to the total weight of natural pozzolan, the addition of acid can act as an accelerator and a water reducer.

### Example 19

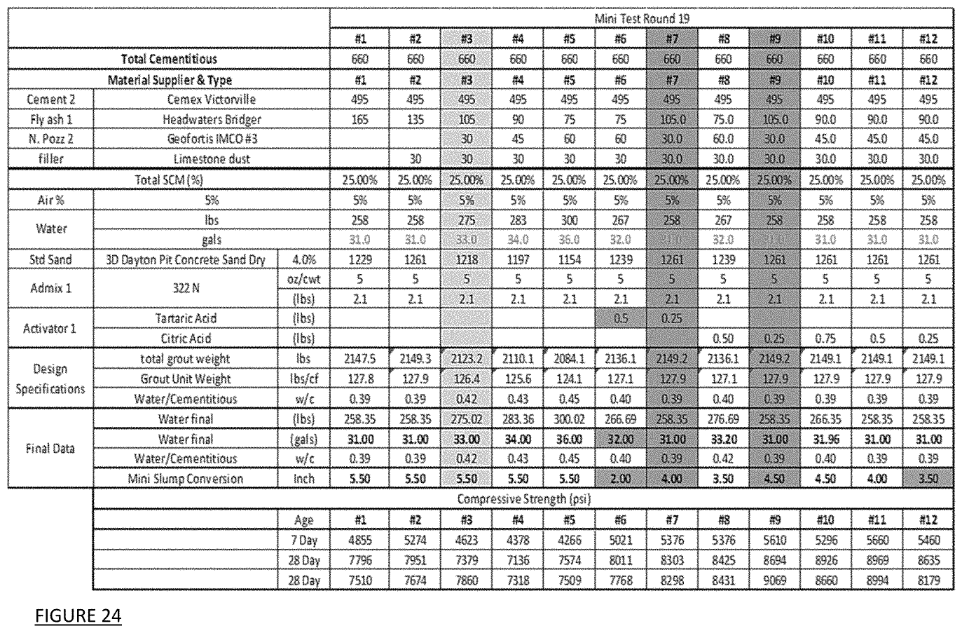

FIG. 24 depicts a chart wherein the shaded mix designs show improved water demand performance, which in turn is expected to improve the strength performance. Both tartaric acid and citric acid can be added to improve water demand; however, citric acid does appear to have a relatively better water demand performance in these tests. The use of acids in small total doses can improve the strength of the mix, as well as reduce the total water required to make the cement.

### Example 20

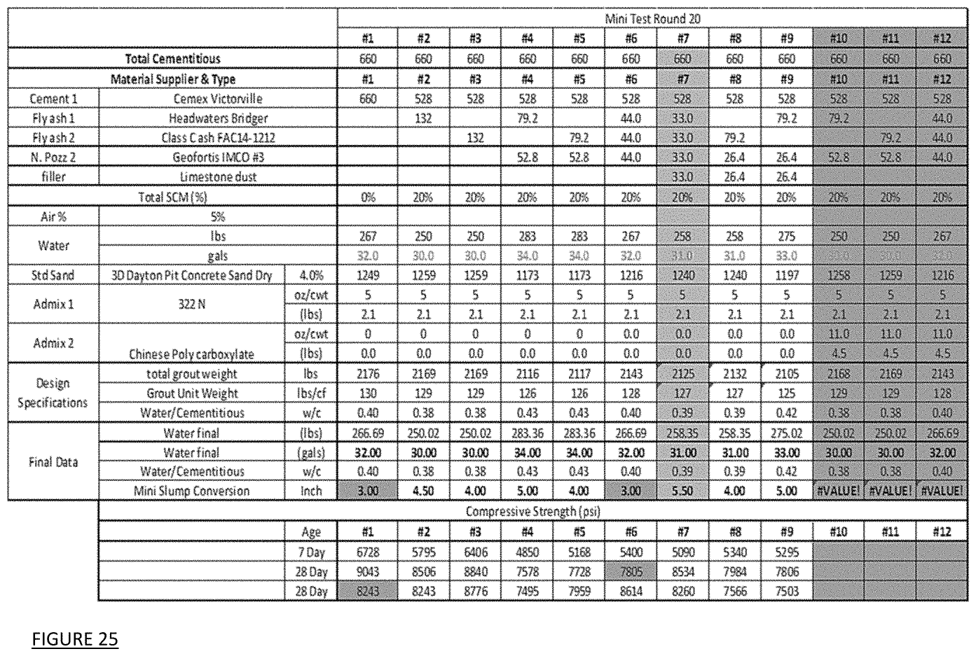

FIG. 25 depicts a chart of test results for limestone dust with the inclusion of C class fly ash. The purpose of this testing is to demonstrate how off-spec fly ash could be used in equal parts to F class fly ash, pozzolan, and limestone dust. Overall, this testing proves to be an excellent example of the viability of extending F class fly ash with both natural pozzolan and/or off-spec fly ash.

### Example 21

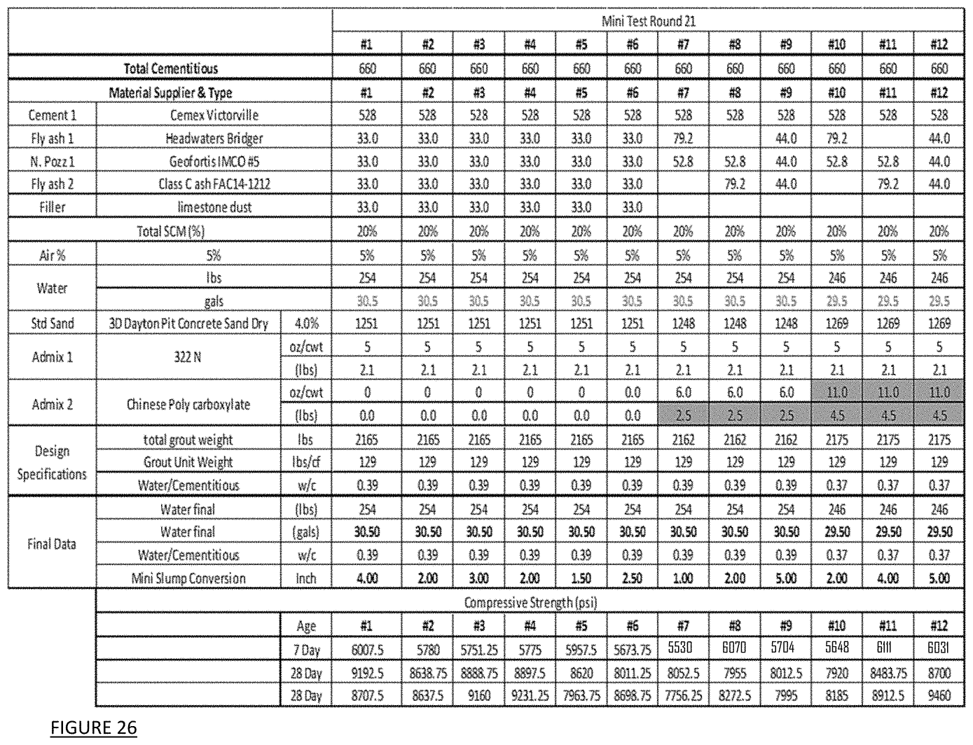

FIG. 26 depicts a chart of test results for a test including a corrected amount of Admix 2, Polycarboxylate. This chart shows that the addition of the second admixture did not significantly increase the performance of the mix designs. The designs where the off-spec fly ash is used as an even split with all other materials still showed promise at roughly 31 gallons of total water.

### Example 22

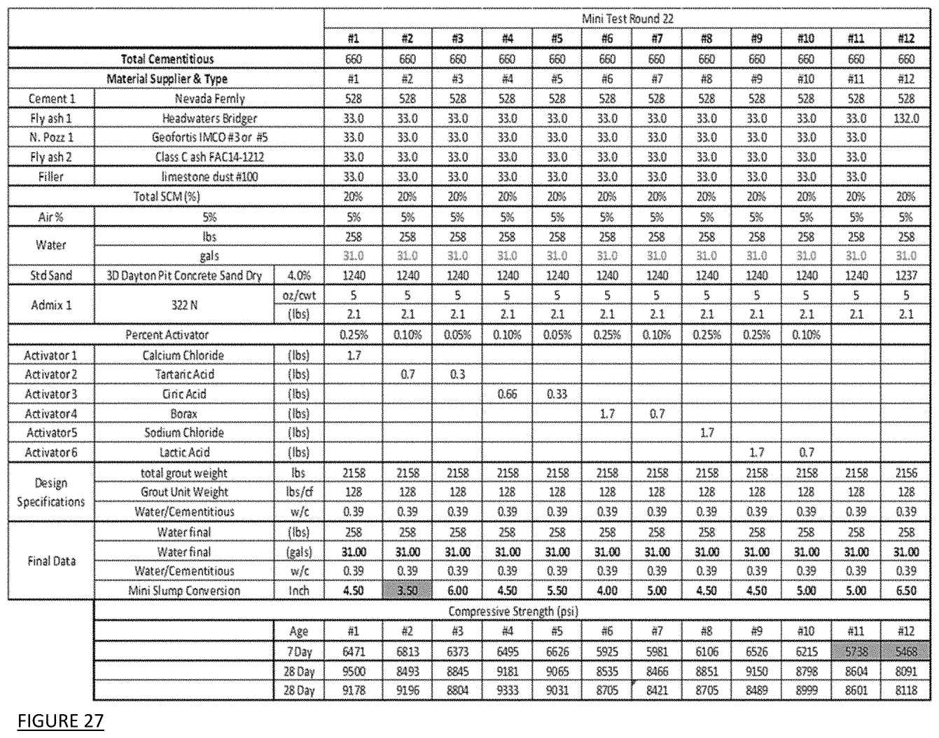

FIG. 27 depicts a chart of test results for off-spec fly ash designs with several activators used. These designs were undertaken to narrow down the best options for reducing water demand and increasing strength of the mixes. The range of tested activators clearly showed the best preforming ones were tartaric acid and citric acid.

### Example 23

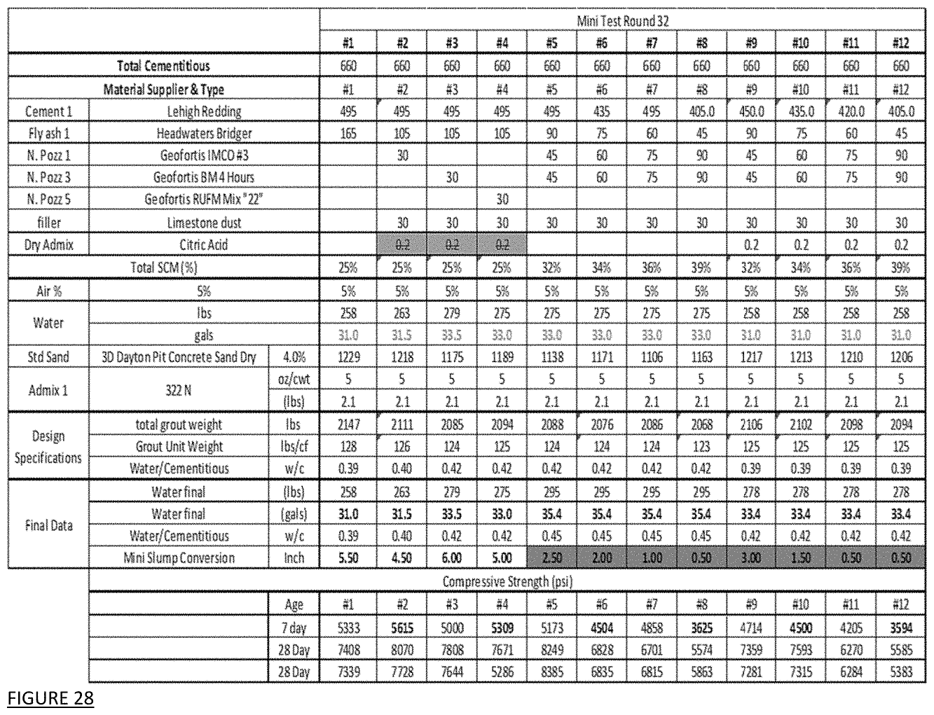

FIG. 28 depicts a chart of test results focusing on the variation of particle size of three natural pozzolan samples having D50 diameters of 7, 17 and 22 microns and the interaction of limestone dust in the SCM design. It is believed that D50 particle size may not be the primary factor driving the water demand within the pozzolanic material in this range.

### Example 24

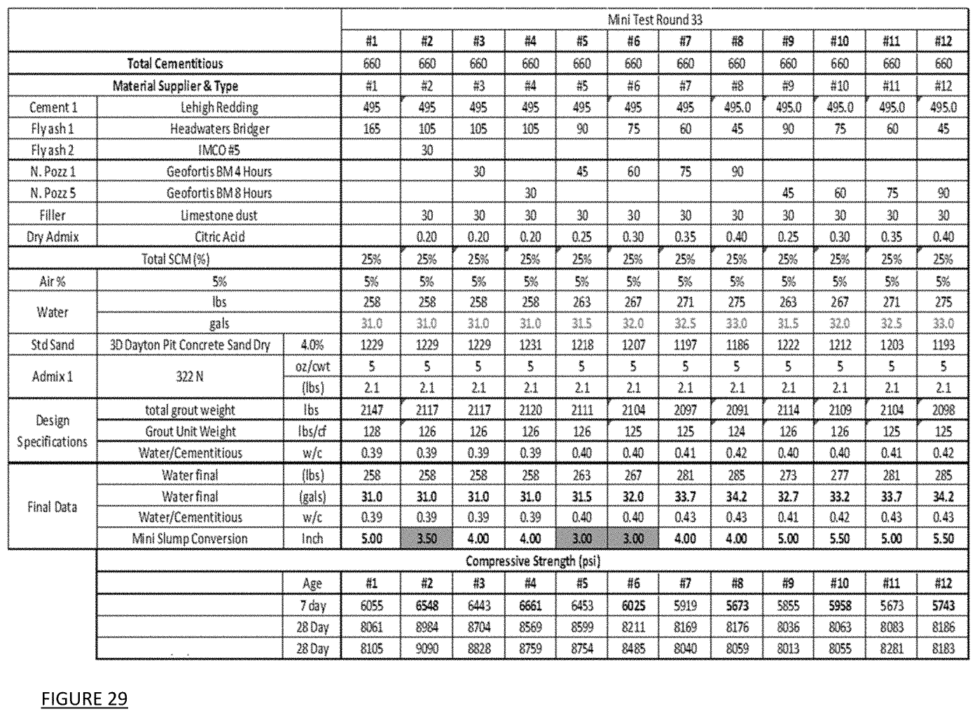

FIG. 29 depicts a chart of test results using ball-milled pozzolanic material with limestone dust and citric acid to establish good water demand statistics as well as benchmark strengths.

### Example 25

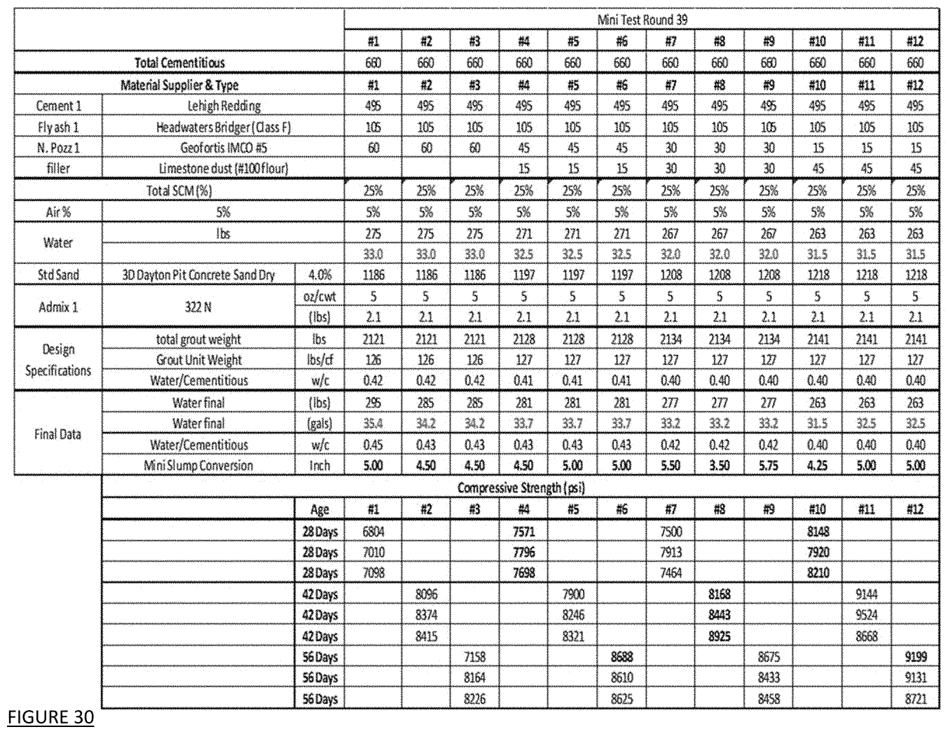

FIG. 30 depicts a chart of various long-term test results at varied mix ratios to desirably identify some potential upper limits on pozzolan material as well as limestone dust. Pozzolan weight percent in the designs ranged from 10%, to 2%; while limestone dust weight percentages range from 0% to 7%. This testing shows some of the effects of limestone dust and pozzolan concentrations within the SCM design over the long-term life of the concrete. In these examples, as pozzolan content was removed and replaced by limestone dust, there was an increase in water reduction and strength at the long-term end. This data was valuable in establishing solid comparative trends between natural pozzolan and limestone.

### Example 26

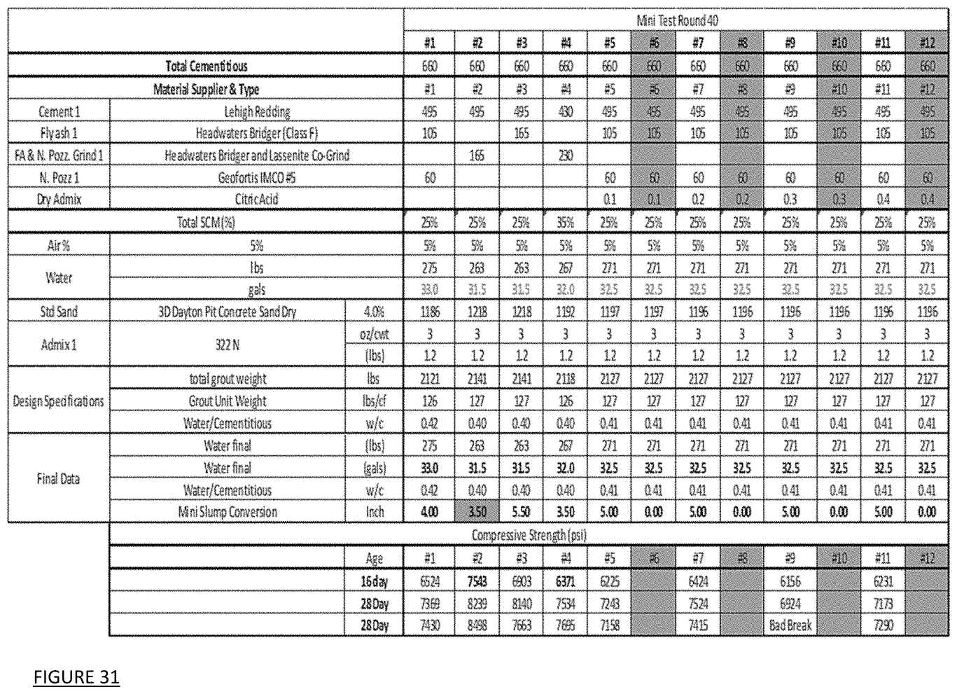

FIG. 31 depicts a chart of tests including Inter-Grinding of concrete constituents. This test was accomplished at a ratio of 4:1 in the Bridger/Lassenite Co-Grind (Fly Ash, Pozzolan), which were milled together and then used in the design of the SCM cement. As shown by the red boxed slump, at 25% replacement the material used 31.5 gallons of water. Shown in mix number four the product at 35% used 32 gallons.

### Example 27

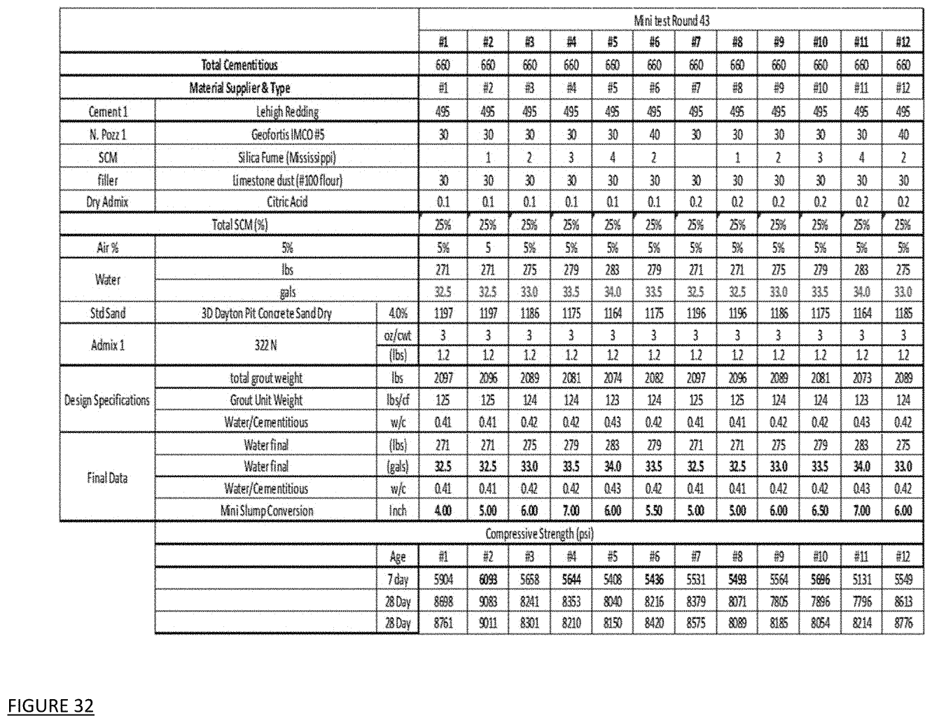

FIG. 32 depicts a chart of tests incorporating silica fume into concrete mixes that were designed to increase strength without hindering water reduction efforts. The additions of small amounts of silica fume is done in the attempts to increase the strength of the mix a few hundred PSI without impacting water demand negatively. These mixes were designed to test the viability of silica fume as a SCM that would desirably give additional strength performance without negative impacts to water demand—and as such the amounts of silica fume used are very low. As seen in all of the results, the water demand of the final cement actually remains constant at 32.5 gallons, to achieve roughly a five-inch slump.

### Example 28

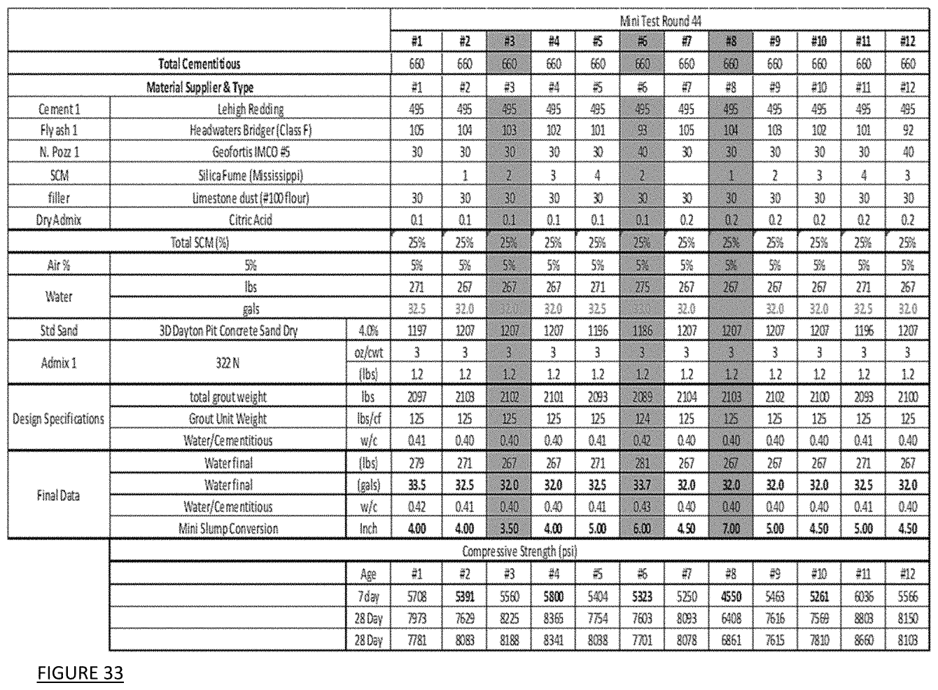

FIG. 33 depicts a chart of tests incorporating silica fume into concrete mixes that included slightly modified water values to see if the strengths and slumps were accurate. Slight testing variations occurred; however, it is clear that the water demand did remain roughly constant. This testing confirmed that the silica fume water demand remained constant at 32.5 gallons. The overall strength performance also remained roughly constant. Further testing was then done at higher and higher concentrations of silica fume and limestone dust in an attempt to push strength as high as possible without increasing water demand.

### Example 29

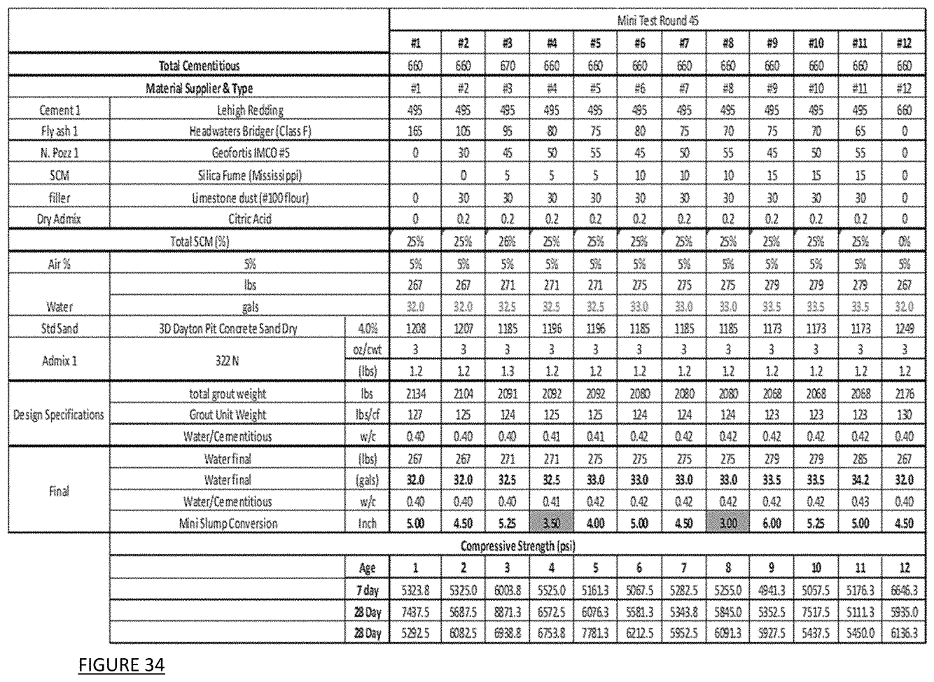

FIG. 34 depicts a chart of tests incorporating high silica fume replacement percentages in further attempts to gain higher strength. In these results, as silica fume weight increases there was no significant increase in strength, but strength is only one performance parameter. These mixes will desirably exhibit very low permeability and improved ASR mitigation.

### Example 30

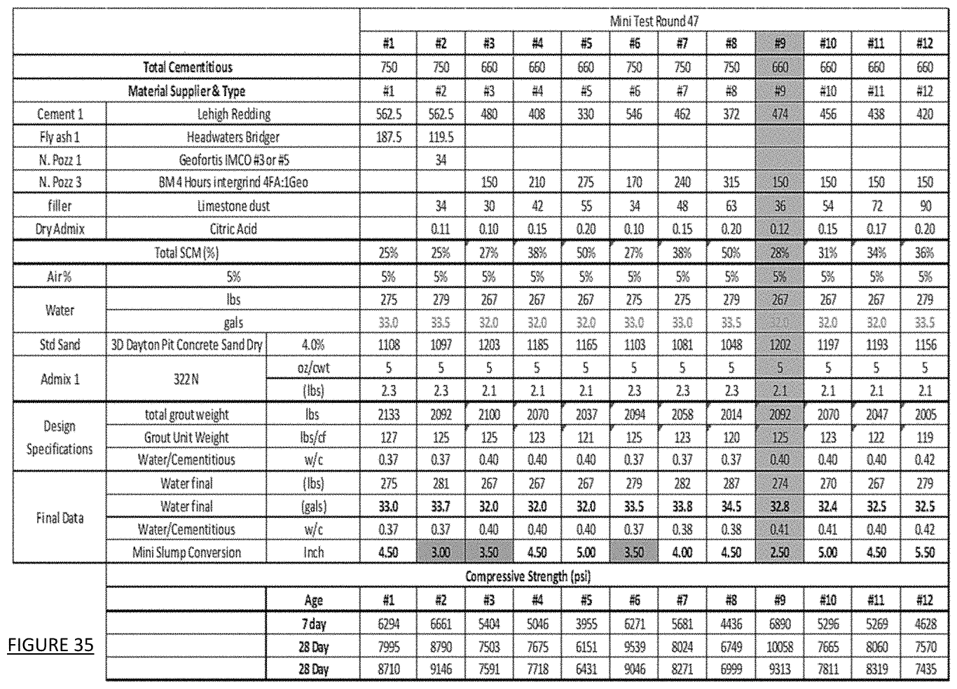

FIG. 35 depicts a chart of tests incorporating inter-grinds, including high replacement with increasing limestone dust replacement. As the total weight of inter-grind product was increased the limestone dust weight was also increased, leading to a test range of 27% to 50% total replacement, which were mixes number three through eight. Mixes number nine through twelve show a constant weight of inter-grind product with an increasing limestone dust weight. Mix number nine had an error while being mixed that caused an increase in water demand.

As expected, the water demand continued to rise as the inter-grind product weight was increased, with the highest water demand occurring at 50% replacement. This also corresponded to the lowest strength of the high replacement inter-grind mix designs. The high limestone dust content mix designs had a much lower and more stable water demand, as well as a much more stable strength. Overall this confirms that the total mass of pozzolan contained within the SCM design is driving the largest portion of water demand, and as a result is likely the leading issue with strength. In addition to confirming the water demand issue and strength issue, this test confirms that the use of inter-grind derived products leads to better water control and better strengths, as similar tests with 50% total replacement using fly ash, natural pozzolan, and limestone dust have had higher water demands, and even lower strengths.

### Example 31

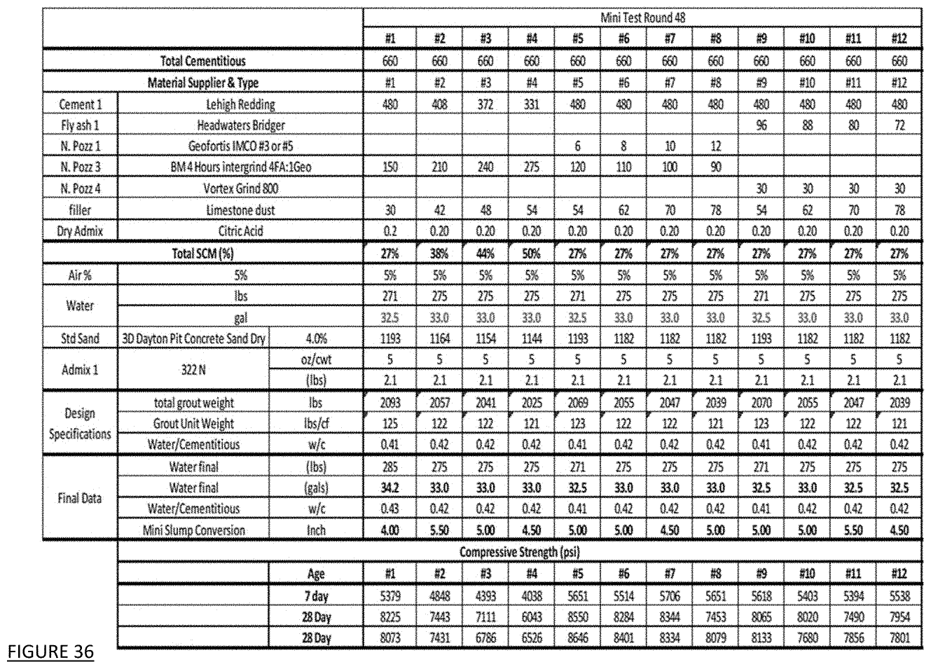

FIG. 36 depicts a chart of tests incorporating constant pozzolan mass with increasing limestone dust mass. This set of testing was done to desirably establish a maximum concentration performance of limestone dust, wherein the total mass of fly ash was reduced, while the pozzolan mass was held constant and the mass of limestone dust was increased. As fly ash weight was reduced there is a loss in water reduction that was slightly made up for by the limestone dust inclusion. There also is a less noticeable strength drop off at the higher end of limestone dust replacing fly ash. Mix designs number five through twelve appear comparable to mix design number one, which is the established control.

### Example 32

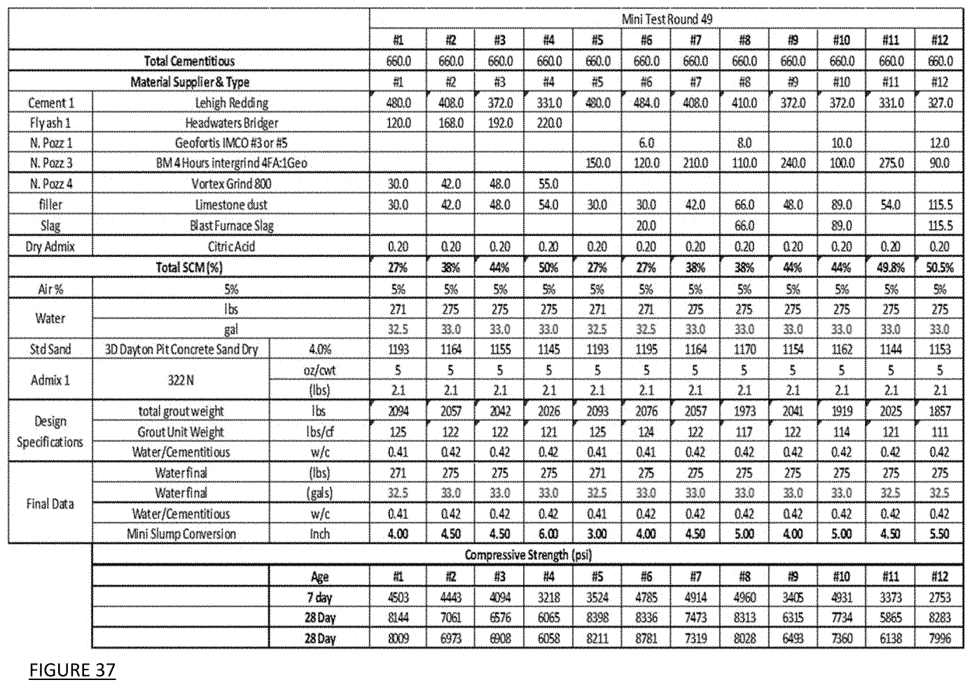

FIG. 37 depicts a chart of tests incorporating new grinding processes for the first four mixes; with the remaining mixes testing techniques to remove more fly ash from the design all while holding the total mass of natural pozzolan constant. The inclusion of blast furnace slag was an attempt to increase strength of the design. Mix eleven is roughly a 50% total replacement design using mostly the pozzolan inter-grind material with a relatively high mass of limestone dust. This resulted in decent water demand performance, but relatively poor strength performance. In comparison, mix number twelve has the same total replacement value, the same pozzolan mass, but has over double the limestone dust mass, and a matching slag mass. By making the design in this manner the total mass of fly ash used is reduced to 72 pounds, but the strength performance is maintained at 28 days.

### Example 33

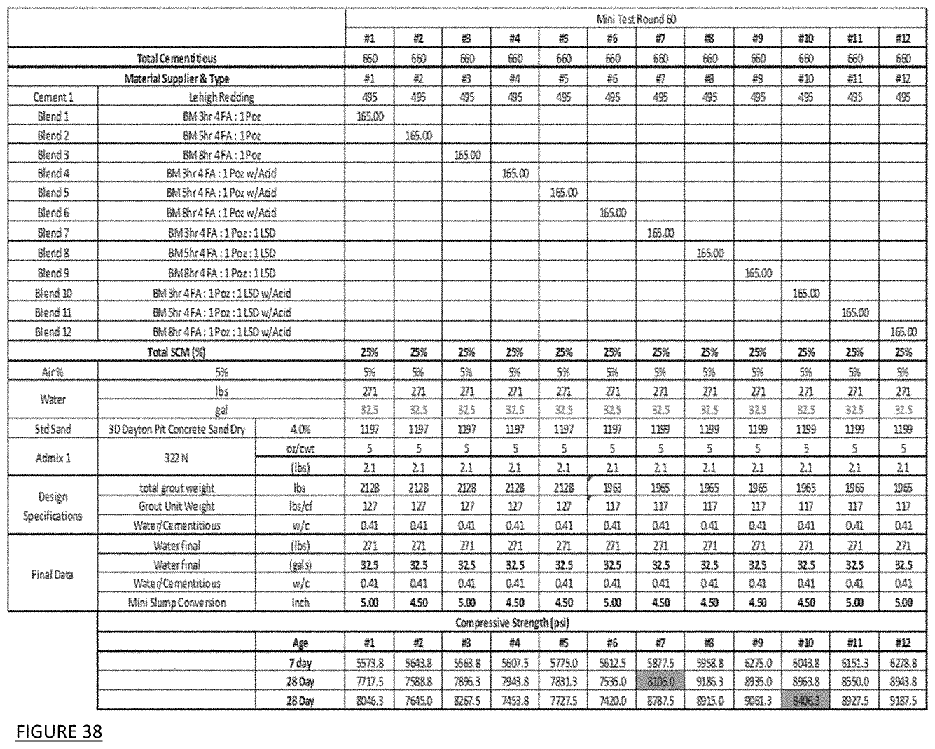

FIG. 38 depicts a chart of tests incorporating various inter-grinds, with mix designs formulated to establish performance characteristics for inter-ground products at 25% total replacement. The addition of acid in various mix names indicates that acid has been added at one pound per one short ton of pozzolan.

In these test, as inter-grind times increased, the overall strength performance increased while water demand remained a constant 32.5 gallons. These are excellent results for establishing the viability of inter-grinding the fly ash, pozzolan, and limestone dust. The shaded boxes indicate bad breaks, which were established by not only comparing the data with others on this test but also comparing them to others done on other tests. The inclusion of the acid during the entirety of the grinding time seems to have little effect on the overall performance of the mix, thus it is probable that the acid is reacting with excess moisture during the grinding time. Drier powders or blending at a later time may be more successful.

### Example 34

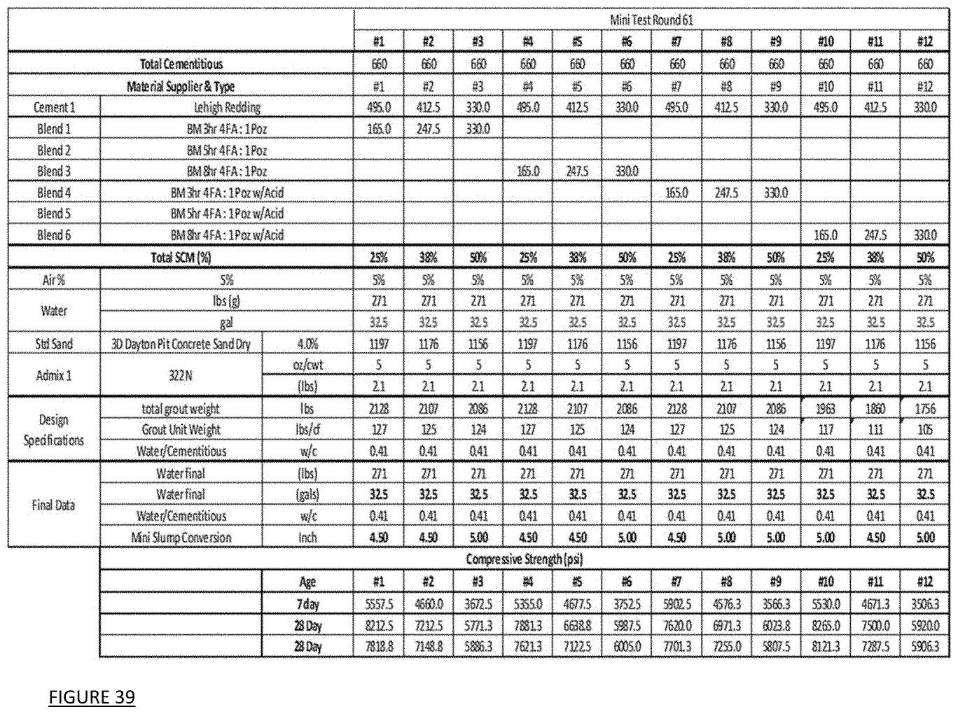

FIG. 39 depicts a chart of tests incorporating high replacement of inter-ground fly ash and natural pozzolan, where it was attempted to find a total percent replacement where water demand and strength performance would fall outside a desired limit. This testing indicated that there is no appreciable water demand change from 25% to 50% total replacement when using these inter-ground products, which indicates that the particle size distribution for these inter-ground products allows for much better water demand control.

### Example 35

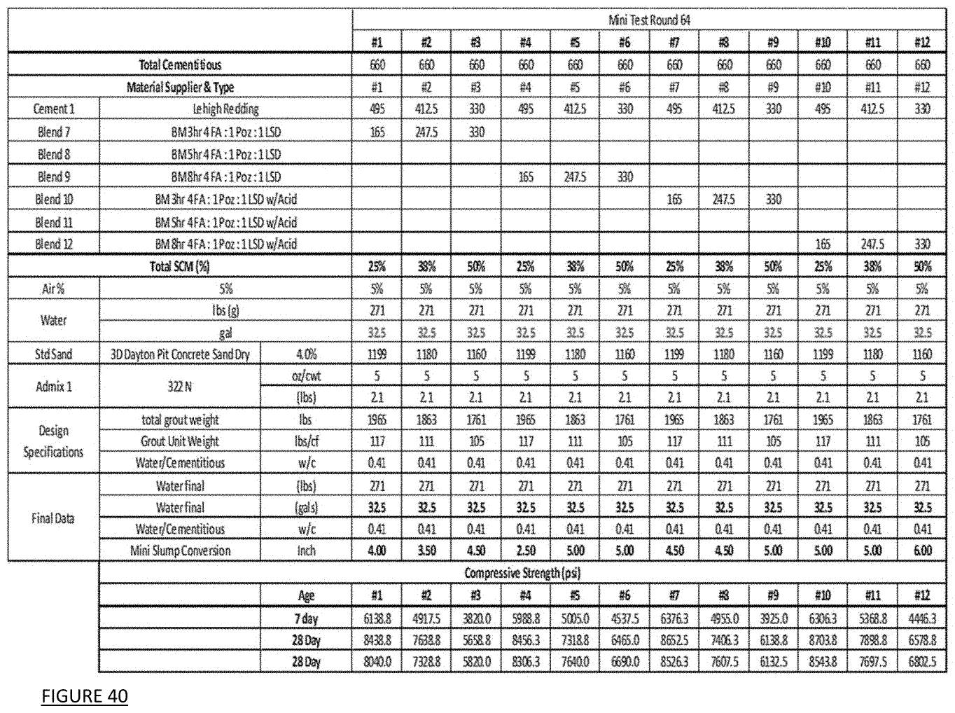

FIG. 40 depicts a chart of tests incorporating high replacement inter-grind fly ash, natural pozzolan and limestone dust. This testing was done to desirably define an upper limit of total percent replacement that could be used without compromising the water demand or the strength of each mix. If compressive strength is the only performance parameter being considered then the upper limit seemed to fall around the 40% total replacement range, as the strengths fell outside of a desired tolerance range at 50% total replacement. Higher replacements (above 40%) may be beneficial when other performance characteristics are required such as low heat of hydration. The acid interaction and performance was not clear, and more testing was conducted to determine if acid inclusion within the grinding phase is of benefit.

### Example 36

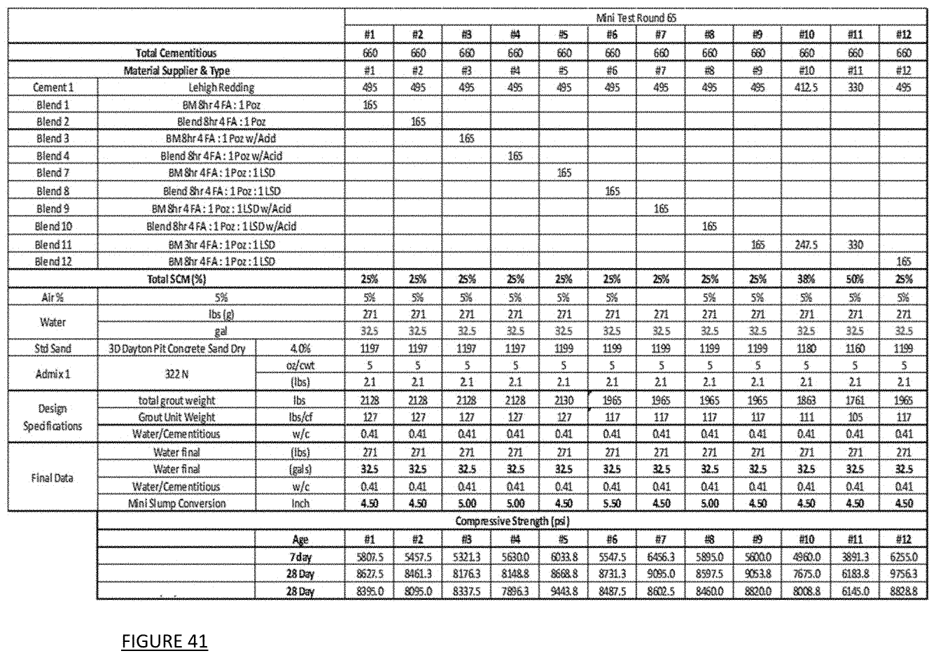

FIG. 41 depicts a chart of tests of concrete mixes comparing blending of cement constituents versus inter-grinding of various constituents. The goal of these mix designs is to test whether blending all of the products for a large amount of time in bulk would yield better or the same results as inter-grinding. In the attempt to narrow down ultimate product design and feasibility, a portable ⅓ cy concrete mixer was used to create blended product with the same weight composition as the inter-ground products. The two types of products were then tested at 25% total replacement in an attempt to discern a clear set of patterns when it came to water demand, strength, product creation technique, and mix composition.

In this testing, mixes number 3 and 4 clearly indicated a trend of acid interaction within the inter-ground products. The long-term strength is not improved by using the blend; however, the early strength is increased, which is believed to be due to the intact acid acting as an activator within the blended product, whereas the acid is not reacting within the inter-ground product. While neither product displayed an advantage with regard to water demand, the early strength gain would point to using a blended product; however, mix numbers seven and eight show that the inter-ground products can significantly outperform the blended products. Further testing was done to verify the trend that inter-ground products outperformed the blended products when limestone dust was included, and it confirmed this conclusion.

### Example 37

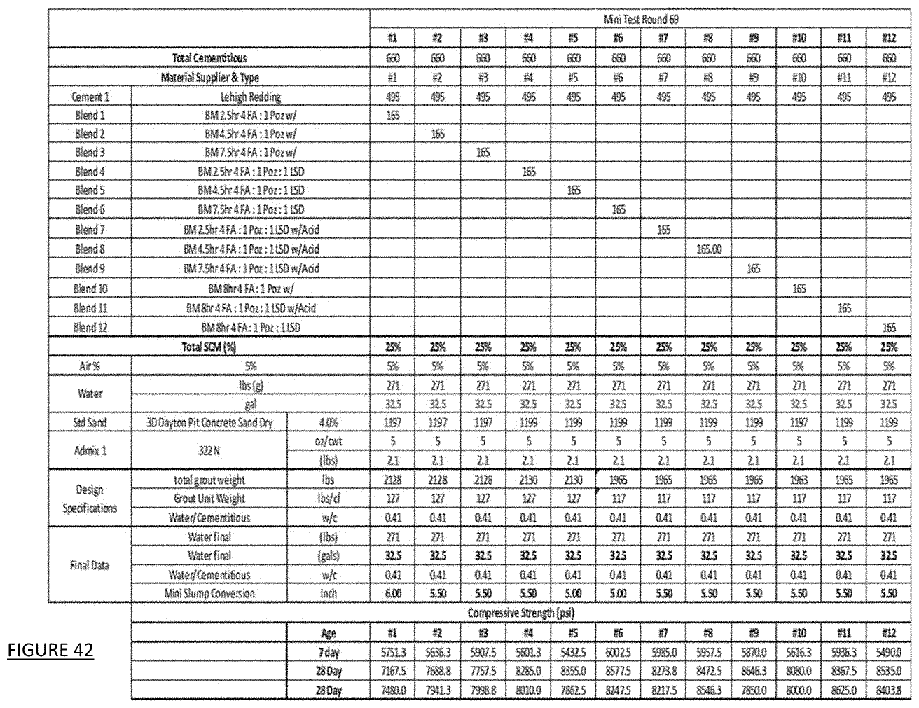

FIG. 42 depicts a chart of tests of concrete designs to determine whether long grind times including acid was causing poor acid performance. The acid was added within the last thirty minutes of the inter-grinding process. IE, BM 2.5 hr 4FA:1Poz indicates that for two and a half hours the mill was run with just fly ash and pozzolan, then for an additional thirty minutes the mill was run with fly ash, pozzolan, and acid. In the case where limestone dust was used in the design the limestone dust was added at the last thirty minutes, similar to the acid addition. The late addition of acid had a slight impact on water demand, which was evidenced by the slightly higher slump values. While none of the designs fell outside of a desired level, the effect of added the acid at the end of the mill time potentially indicates that milling the acid for the full duration of inter-grinding results in the potential loss of the acid effect. The strengths of these designs fell within the range of other inter-grind products.

### CONCLUSIONS

In summary, Applicant's rapid developments have led to the current novel and unique design approach of blending and inter-grinding SCMs and/or other concrete constituents to create viable high replacement mix designs that attempt to solve both the water demand issues and strength issues of existing cement formulations, which in many cases are accomplished at a fraction of the cost of current additive and mix solutions. Applicant's cement mixes have attained an average 28-day strength of 9293 psi, which is only about 200 psi lower than the highest average pure cement control on record, which was achieved with a water demand of 32.5 gallons at a total batch weight of 660 pounds. In contrast, the pure cement, at a total batch weight of 660 pounds, would be expected to consume anywhere from 33 to 33.5 gallons of water.

While the invention has been described with reference to certain specific embodiments thereof, it should be understood that it is not to be so limited, since alterations and/or changes may be made therein which are within the full intended scope of the appended claims. All quantities, proportions and percentages are by weight and all references to temperature are ° C. unless otherwise indicated. As used herein, the terms “major” and “minor”, applied to amounts, shall mean at least 50% by weight and less than 50% by weight, respectively.

It should be understood that not all mills and/or mill types may be able to economically inter-grind the calcium carbonate and natural pozzolan to a desired fineness (i.e., D50 less than 10 microns in some embodiments); but, when ground to approximate (and/or exceed) this fineness, the inter-grind powder can desirably exhibit greatly reduced water demand when utilized in concrete mixtures. Since there is often a direct correlation between water demand and concrete strength, reducing water may have the advantage of improving compressive strength of the mix and other positive attributes of the concrete. At a minimum, the water demand in concrete of certain natural pozzolans should be greatly reduced by inter-grinding of calcium carbonate in certain types of mills (i.e., attrition mills) to a desired and/or minimum fineness.

All references, including publications, patent applications, and patents, cited herein are hereby incorporated by reference to the same extent as if each reference were individually and specifically indicated to be incorporated by reference and were set forth in its entirety herein.

The various headings and titles used herein are for the convenience of the reader, and should not be construed to limit or constrain any of the features or disclosures thereunder to a specific embodiment or embodiments. It should be understood that various exemplary embodiments could incorporate numerous combinations of the various advantages and/or features described, all manner of combinations of which are contemplated and expressly incorporated hereunder.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., i.e., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including various best modes known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A pozzolanic composition for use in concrete and mortar, the composition comprising a natural pozzolan in concentration of 1 wt % to about 99 wt % and a calcium carbonate source inter-ground in an attrition-type mill to a fineness such that a median particle size D50 is equal or less than 25 microns.

2. The pozzolanic composition of claim 1, wherein the inter-ground combination of the natural pozzolan and calcium carbonate source have significantly lower water requirements in concrete as compared to the natural pozzolan by itself.

3. The pozzolanic composition of claim 1, wherein a weight ratio of said natural pozzolan is in a concentration of about 50 wt % to 90 wt %.

4. The pozzolanic composition of claim 1, wherein said natural pozzolan is a volcanic ash and/or diatomaceous earth with pozzolanic properties.

5. The pozzolanic composition of claim 1, wherein the natural pozzolan comprises LASSENITE natural pozzolan.

6. The pozzolanic composition of claim 1, wherein said natural pozzolan is calcined.

7. The pozzolanic composition of claim 1, wherein the natural pozzolan and the calcium carbonate source are inter-ground in an attrition-type mill to a fineness such that a median particle size D50 is equal or less than 10 microns.

8. The pozzolanic composition of claim 1, wherein the calcium carbonate source comprises a limestone aggregate with a median approximate size selected from the group consisting of 4″, 3.5″ 3″ 2.5″ 2″, 1.5″, 1″, 0.75″, 0.5″, 0.375″, #4, #8, #10, #16, #20, #30, #40, #50, #100 and #200.

9. A method of dispersing a calcium carbonate source through a cementitious composition comprising a natural pozzolan and at least one additional constituent, the method comprising the steps of inter-grinding a calcium carbonate source with the natural pozzolan to create an inter-ground calcium-pozzolan material prior to blending the inter-ground calcium-pozzolan material with the at least one additional constituent.

10. The method of claim 9, wherein the natural pozzolan comprises LASSENITE natural pozzolan.

11. The method of claim 9, wherein the calcium carbonate source comprises a limestone aggregate and the inter-grinding of the limestone aggregate with the natural pozzolan produces an inter-ground calcium-pozzolan powder having a median particle size D50 equal to or less than 10 microns.

12. The method of claim 9, wherein the calcium source comprises a limestone aggregate and the inter-grinding of the limestone aggregate with the natural pozzolan produces an inter-ground calcium-pozzolan powder having a median particle size D50 equal to or less than 25 microns.

13. The method of claim 11, wherein a median particle size D50 of the limestone aggregate is selected from the group consisting of 4″, 3.5″ 3″ 2.5″ 2″, 1.5″, 1″, 0.75″, 0.5″, 0.375″, #4, #8, #10, #16, #20, #30, #40, #50, #100 and #200.

14. The method of claim 9, wherein the at least one additional constituent comprises Portland cement.

15. The method of claim 9, wherein the at least one additional constituent comprises blast furnace slag.

16. The method of claim 9, wherein the at least one additional constituent comprises fly ash.

17. The method of claim 16, wherein the fly ash comprises a non-spec fly ash.

18. A method of reducing a water demand of a cementitious composition comprising a natural pozzolan and a calcium carbonate source, the method comprising the steps of inter-grinding the calcium carbonate source with the natural pozzolan to create an inter-ground calcium-pozzolan material prior to blending the inter-ground calcium-pozzolan material with water.

19. The method of claim 18, further comprising the step of blending the inter-ground calcium-pozzolan material with Portland cement prior to blending the inter-ground calcium-pozzolan material with water.

20. A cementitious composition comprising the pozzolanic composition of claim 1 in combination with Portland cement.
